(19) United States
(12) Patent Application Publication
(10) Pub. No.: US 2025/0226594 A1
(43) Pub. Date: Jul. 10, 2025

(54) ORBITAL ANGULAR MOMENTUM MULTIPLEXING USING MULTIPLE MODES IN AN ANTENNA ARRAY

(71) Applicant: QUALCOMM INCORPORATED, San Diego, CA (US)

(72) Inventors: Danlu Zhang, San Diego, CA (US); Min Huang, Beijing (CN); Chao Wei, Beijing (CN); Juergen Cezanne, Ocean Township, NJ (US); Meilong Jiang, Westfield, NJ (US); Yu Zhang, San Diego, CA (US); Hao Xu, Beijing (CN); Junyi Li, Greentown, PA (US); Allen Minh-Triet Tran, Rancho Santa Fe, CA (US)

(21) Appl. No.: 18/851,031

(22) PCT Filed: May 10, 2022
(86) PCT No.: PCT/CN2022/091891

§ 371 Date: Sep. 25, 2024

(51) Int. Cl. H01Q 21/20; H01Q 1/24; H01Q 21/24

(52) U.S. Cl. CPC H01Q 21/20; H01Q 1/24; H01Q 21/24

(57) ABSTRACT

Methods, systems, and devices for wireless communication are described. In some systems, a first device may generate a plurality of signals via a first circular antenna array that contains a first quantity of antenna elements disposed in a circle. The first device may transmit a first signal of the plurality of signals using a first orbital angular momentum (OAM) mode and a first subset of the first quantity of antenna elements. Additionally, the first device may transmit, a second signal of the plurality of signals using a second (OAM) mode and a second subset of the first quantity of antenna elements, where the second subset may be exclusive of the first subset.

### CROSS REFERENCE

The present Application is a 371 national stage filing of International PCT Application No. PCT/CN2022/091891 by Zhang et al. entitled “ORBITAL ANGULAR MOMENTUM MULTIPLEXING USING MULTIPLE MODES IN ANTENNA ARRAY,” filed May 10, 2022, which is assigned to the assignee hereof, and which is expressly incorporated by reference in its entirety herein.

### FIELD OF TECHNOLOGY

The following relates to wireless communication, including orbital angular momentum multiplexing using multiple modes in an antenna array.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some devices of a wireless communications system may support orbital angular momentum (OAM) multiplexing to increase throughput and reduce latency. Devices that support OAM multiplexing may use circular antenna arrays to transmit and receive communications via an OAM multiplexing scheme.

### SUMMARY

The described techniques relate to improved methods, systems, devices, and apparatuses that support orbital angular momentum (OAM) multiplexing using multiple modes in an antenna array. For example, the described techniques provide for a first device (e.g., a transmitting network node) that includes a first quantity of antenna elements to support OAM communications with a second device (e.g., a receiving network node that includes a second quantity of antenna elements). The transmitting network node and the receiving network node may each include the respective quantities of antenna elements disposed in a respective circular antenna array. For example, the transmitting network node may include a first circular antenna array including the first quantity of antenna elements, which may be referred to as a transmitter circle, and the receiving network node may include a second circular antenna array including the second quantity of antenna elements, which may be referred to as a receiver circle.

The network nodes may support OAM communications by communicating a plurality of signals in the form of multiple coaxially propagating, spatially-overlapping waves, wherein each of the waves may be associated with an OAM mode. For example, the transmitting network node may generate a plurality of signals for transmission from the transmitting network node to the receiving network node by using the first circular antenna array. The transmitting network node may transmit a first signal of the plurality of signals via a first OAM mode by utilizing a first subset of the first quantity of antenna elements in the first circular antenna array. Additionally, the transmitting network node may transmit a second signal of the plurality of signals via a second OAM mode by utilizing a second subset of the first quantity of antenna elements in the first circular antenna array that is different from the first subset. In some aspects, the transmitting network node may transmit the first signal using the first OAM mode and the second signal using the second OAM mode based on transmitting a capability message specifying a multimode transmission mode, and receiving, from the receiving network node, a feedback message indicating that the transmitting network node may use the multimode transmission mode specified in the capability message.

A method for wireless communication at a first device is described. The method may include generating a set of multiple signals for transmission from the first device via a first circular antenna array that includes a first quantity of antenna elements disposed in a circle, transmitting a first signal of the set of multiple signals using a first orbital angular momentum mode and a first subset of the first quantity of antenna elements disposed in the circle, and transmitting a second signal of the set of multiple signals using a second orbital angular momentum mode and a second subset of the first quantity of antenna elements disposed in the circle, where the second subset is exclusive of the first subset.

An apparatus for wireless communication at a first device is described. The apparatus may include a processor, memory coupled with the processor, and instructions stored in the memory. The instructions may be executable by the processor to cause the apparatus to generate a set of multiple signals for transmission from the first device via a first circular antenna array that includes a first quantity of antenna elements disposed in a circle, transmit a first signal of the set of multiple signals using a first orbital angular momentum mode and a first subset of the first quantity of antenna elements disposed in the circle, and transmit a second signal of the set of multiple signals using a second orbital angular momentum mode and a second subset of the first quantity of antenna elements disposed in the circle, where the second subset is exclusive of the first subset.

Another apparatus for wireless communication at a first device is described. The apparatus may include means for generating a set of multiple signals for transmission from the first device via a first circular antenna array that includes a first quantity of antenna elements disposed in a circle, means for transmitting a first signal of the set of multiple signals using a first orbital angular momentum mode and a first subset of the first quantity of antenna elements disposed in the circle, and means for transmitting a second signal of the set of multiple signals using a second orbital angular momentum mode and a second subset of the first quantity of antenna elements disposed in the circle, where the second subset is exclusive of the first subset.

A non-transitory computer-readable medium storing code for wireless communication at a first device is described. The code may include instructions executable by a processor to generate a set of multiple signals for transmission from the first device via a first circular antenna array that includes a first quantity of antenna elements disposed in a circle, transmit a first signal of the set of multiple signals using a first orbital angular momentum mode and a first subset of the first quantity of antenna elements disposed in the circle, and transmit a second signal of the set of multiple signals using a second orbital angular momentum mode and a second subset of the first quantity of antenna elements disposed in the circle, where the second subset is exclusive of the first subset.

Some examples of the method, apparatuses, and non-transitory computer-readable medium described herein may further include operations, features, means, or instructions for transmitting an capability message specifying that that the first device may be capable of transmitting signals using a multimode transmission mode including the first orbital angular momentum mode using the first subset of antenna elements disposed in the circle and the second orbital angular momentum mode using the second subset of antenna elements disposed in the circle.

In some examples of the method, apparatuses, and non-transitory computer-readable medium described herein, transmitting the capability message may include operations, features, means, or instructions for transmitting the capability message using a radio resource control signal or a system broadcast signal.

Some examples of the method, apparatuses, and non-transitory computer-readable medium described herein may further include operations, features, means, or instructions for receiving, from a second device, a feedback message indicating that the first device may be to use the multimode transmission mode from among a single mode transmission mode and the multimode transmission mode.

Some examples of the method, apparatuses, and non-transitory computer-readable medium described herein may further include operations, features, means, or instructions for transmitting an indication of a topology of the first circular antenna array, where the topology includes a number of circles of the first circular antenna array, a quantity of antenna elements in one or more circles of the first circular antenna array, a quantity of power amplifiers for the one or more circles, a quantity of digital beamformers for the one or more circles, or a combination thereof.

Some examples of the method, apparatuses, and non-transitory computer-readable medium described herein may further include operations, features, means, or instructions for receiving, from a second device, an indication of a topology of a second circular antenna array of the second device, where the topology includes a number of circles of the second circular antenna array, a quantity of antenna elements in one or more circles of the second circular antenna array, a quantity of power amplifiers for the one or more circles, a quantity of digital beamformers for the one or more circles, or a combination thereof.

In some examples of the method, apparatuses, and non-transitory computer-readable medium described herein, transmitting the first signal and transmitting the second signal may include operations, features, means, or instructions for transmitting the first signal using the first orbital angular momentum mode and the second signal using the second orbital angular momentum mode based on a topology of the first circular antenna array, a topology of a second circular antenna array of a second device, or a combination thereof.

In some examples of the method, apparatuses, and non-transitory computer-readable medium described herein, transmitting the first signal and transmitting the second signal may include operations, features, means, or instructions for transmitting the first signal including a first set of reference signals and transmitting the second signal including a second set of reference signals.

Some examples of the method, apparatuses, and non-transitory computer-readable medium described herein may further include operations, features, means, or instructions for receiving, from a second device based on transmitting the first set of reference signals and the second set of reference signals, a feedback message indicating one or more channel quality indications corresponding to each antenna element of the first quantity of antenna elements, each mode of the first orbital angular momentum mode and the second orbital angular momentum mode, or a combination thereof.

Some examples of the method, apparatuses, and non-transitory computer-readable medium described herein may further include operations, features, means, or instructions for transmitting one or more subsequent signals using the first orbital angular momentum mode, the second orbital angular momentum mode, or both, based on the one or more channel quality indications.

In some examples of the method, apparatuses, and non-transitory computer-readable medium described herein, each antenna element of the first subset and each antenna element of the second subset may be disposed in the circle in an alternating pattern.

In some examples of the method, apparatuses, and non-transitory computer-readable medium described herein, transmitting the first signal and transmitting the second signal may include operations, features, means, or instructions for transmitting the first signal using a first power applied by a first power amplifier corresponding to the first subset of antenna elements and the first orbital angular momentum mode and transmitting the second signal using a second power applied by a second power amplifier corresponding to the second subset of antenna elements and the second orbital angular momentum mode.

Some examples of the method, apparatuses, and non-transitory computer-readable medium described herein may further include operations, features, means, or instructions for applying a set of beamforming weights for transmission of the first signal and the second signal using a first quantity of phasors, where each phasor of the first quantity of phasors corresponds to a respective antenna element of the first quantity of antenna elements.

Some examples of the method, apparatuses, and non-transitory computer-readable medium described herein may further include operations, features, means, or instructions for generating a second set of multiple signals for transmission from the first device via the first circular antenna array that includes a second quantity of antenna elements disposed in a second circle, transmitting a first signal of the second set of multiple signals using a third orbital angular momentum mode and a first subset of the second quantity of antenna elements disposed in the second circle, and transmitting a second signal of the second set of multiple signals using a fourth orbital angular momentum mode and a second subset of the second quantity of antenna elements disposed in the second circle, where the second subset of the second quantity of antenna elements may be exclusive of the first subset of the second quantity of antenna elements and where the circle and the second circle may be concentric.

In some examples of the method, apparatuses, and non-transitory computer-readable medium described herein, the first quantity of antenna elements may be positioned at a first set of radial lines of the circle and the second quantity of antenna elements may be positioned a second set of radial lines in the second circle and the second set of radial lines may be offset between the first set of radial lines.

In some examples of the method, apparatuses, and non-transitory computer-readable medium described herein, the first quantity of antenna elements may be positioned at a first set of radial lines of the circle and the second quantity of antenna elements may be positioned a second set of radial lines in the second circle and the second set of radial lines may be parallel with the first set of radial lines.

In some examples of the method, apparatuses, and non-transitory computer-readable medium described herein, transmitting the first signal and transmitting the second signal may include operations, features, means, or instructions for transmitting, to a second device, the first signal and the second signal using the first quantity of antenna elements that may be radially offset from a second quantity of antenna elements of the second device.

A method for wireless communication at a first device is described. The method may include receiving, at a first circular antenna array including a first quantity of antenna elements disposed in a circle, a first signal of a set of multiple signals using a first orbital angular momentum mode and a first subset of the first quantity of antenna elements disposed in the circle, receiving a second signal of the set of multiple signals using a second orbital angular momentum mode and a second subset of the first quantity of antenna elements disposed in the circle, where the second subset is exclusive of the first subset, and decoding the first signal received using the first orbital angular momentum mode and the first subset and the second signal received using the second orbital angular momentum mode and the second subset.

An apparatus for wireless communication at a first device is described. The apparatus may include a processor, memory coupled with the processor, and instructions stored in the memory. The instructions may be executable by the processor to cause the apparatus to receive, at a first circular antenna array including a first quantity of antenna elements disposed in a circle, a first signal of a set of multiple signals using a first orbital angular momentum mode and a first subset of the first quantity of antenna elements disposed in the circle, receive a second signal of the set of multiple signals using a second orbital angular momentum mode and a second subset of the first quantity of antenna elements disposed in the circle, where the second subset is exclusive of the first subset, and decode the first signal received using the first orbital angular momentum mode and the first subset and the second signal received using the second orbital angular momentum mode and the second subset.

Another apparatus for wireless communication at a first device is described. The apparatus may include means for receiving, at a first circular antenna array including a first quantity of antenna elements disposed in a circle, a first signal of a set of multiple signals using a first orbital angular momentum mode and a first subset of the first quantity of antenna elements disposed in the circle, means for receiving a second signal of the set of multiple signals using a second orbital angular momentum mode and a second subset of the first quantity of antenna elements disposed in the circle, where the second subset is exclusive of the first subset, and means for decoding the first signal received using the first orbital angular momentum mode and the first subset and the second signal received using the second orbital angular momentum mode and the second subset.

A non-transitory computer-readable medium storing code for wireless communication at a first device is described. The code may include instructions executable by a processor to receive, at a first circular antenna array including a first quantity of antenna elements disposed in a circle, a first signal of a set of multiple signals using a first orbital angular momentum mode and a first subset of the first quantity of antenna elements disposed in the circle, receive a second signal of the set of multiple signals using a second orbital angular momentum mode and a second subset of the first quantity of antenna elements disposed in the circle, where the second subset is exclusive of the first subset, and decode the first signal received using the first orbital angular momentum mode and the first subset and the second signal received using the second orbital angular momentum mode and the second subset.

Some examples of the method, apparatuses, and non-transitory computer-readable medium described herein may further include operations, features, means, or instructions for receiving, from a second device, a capability message specifying that that the first device may be capable of transmitting signals using a multimode transmission mode.

In some examples of the method, apparatuses, and non-transitory computer-readable medium described herein, receiving the capability message may include operations, features, means, or instructions for receiving the capability message using a radio resource control signal or a system broadcast signal.

Some examples of the method, apparatuses, and non-transitory computer-readable medium described herein may further include operations, features, means, or instructions for transmitting, to the second device, a feedback message indicating that the first device may be to use the multimode transmission mode from among a single mode transmission mode and the multimode transmission mode.

Some examples of the method, apparatuses, and non-transitory computer-readable medium described herein may further include operations, features, means, or instructions for receiving, from a second device, an indication of a topology of a second circular antenna array of the second device, where the topology includes a number of circles of the second circular antenna array, a quantity of antenna elements in one or more circles of the second circular antenna array, a quantity of power amplifiers for the one or more circles, a quantity of digital beamformers for the one or more circles, or a combination thereof.

Some examples of the method, apparatuses, and non-transitory computer-readable medium described herein may further include operations, features, means, or instructions for transmitting, to a second device, an indication of a topology of the first circular antenna array, where the topology includes a number of circles of the first circular antenna array, a quantity of antenna elements in one or more circles of the first circular antenna array, a quantity of power amplifiers for the one or more circles, a quantity of digital beamformers for the one or more circles, or a combination thereof.

In some examples of the method, apparatuses, and non-transitory computer-readable medium described herein, receiving the first signal and the second signal may include operations, features, means, or instructions for receiving the first signal using the first orbital angular momentum mode and the second signal using the second orbital angular momentum mode based on a topology of the first circular antenna array, a topology of a second circular antenna array of a second device, or a combination thereof.

In some examples of the method, apparatuses, and non-transitory computer-readable medium described herein, receiving the first signal and the second signal may include operations, features, means, or instructions for receiving the first signal including a first set of reference signals and receiving the second signal including a second set of reference signals.

Some examples of the method, apparatuses, and non-transitory computer-readable medium described herein may further include operations, features, means, or instructions for transmitting, to a second device based on receiving the first set of reference signals and the second set of reference signals, a feedback message indicating one or more channel quality indications corresponding to each antenna element of a second quantity of antenna elements of the second device, each orbital angular momentum mode used by the second device, or a combination thereof.

In some examples of the method, apparatuses, and non-transitory computer-readable medium described herein, each antenna element of the first subset and each antenna element of the second subset may be disposed in the circle in an alternating pattern.

Some examples of the method, apparatuses, and non-transitory computer-readable medium described herein may further include operations, features, means, or instructions for receiving a third signal using a third orbital angular momentum mode and a first subset of a second quantity of antenna elements disposed in a second circle, receiving a fourth signal using a fourth orbital angular momentum mode and a second subset of the second quantity of antenna elements disposed in the second circle, and decoding the third signal received using the third orbital angular momentum mode and the first subset of the second quantity of antenna elements and the fourth signal received using the fourth orbital angular momentum mode and the second subset of the second quantity of antenna elements.

In some examples of the method, apparatuses, and non-transitory computer-readable medium described herein, the first quantity of antenna elements may be positioned at a first set of radial lines of the circle and the second quantity of antenna elements may be positioned a second set of radial lines in the second circle and the second set of radial lines may be offset between the first set of radial lines.

In some examples of the method, apparatuses, and non-transitory computer-readable medium described herein, the first quantity of antenna elements may be positioned at a first set of radial lines of the circle and the second quantity of antenna elements may be positioned a second set of radial lines in the second circle and the second set of radial lines may be parallel with the first set of radial lines.

Some examples of the method, apparatuses, and non-transitory computer-readable medium described herein may further include operations, features, means, or instructions for receiving, from a second device, the first signal and the second signal using the first quantity of antenna elements that may be radially offset from a second quantity of antenna elements of the second device.

### BRIEF DESCRIPTION OF THE DRAWINGS

FIG. 1 illustrates an example of a wireless communications system that supports orbital angular momentum (OAM) multiplexing using multiple modes in an antenna array in accordance with one or more aspects of the present disclosure.

FIG. 2 illustrates an example of a wireless communications system that supports OAM multiplexing using multiple modes in an antenna array in accordance with one or more aspects of the present disclosure.

FIG. 3 illustrates an example of an OAM antenna array configuration that supports OAM multiplexing using multiple modes in an antenna array in accordance with one or more aspects of the present disclosure.

FIG. 4A and FIG. 4B illustrate an example of OAM antenna array configurations that support OAM multiplexing using multiple modes in an antenna array in accordance with one or more aspects of the present disclosure.

FIG. 5A and FIG. 5B illustrate an example of OAM antenna array configurations that supports OAM multiplexing using multiple modes in an antenna array in accordance with one or more aspects of the present disclosure.

FIG. 6 illustrates an example of OAM antenna array system that supports OAM multiplexing using multiple modes in an antenna array in accordance with one or more aspects of the present disclosure.

FIG. 7 illustrates an example of a process flow that supports OAM multiplexing using multiple modes in an antenna array in accordance with one or more aspects of the present disclosure.

FIGS. 8 and 9 show block diagrams of devices that support OAM using multiple modes in an antenna array in accordance with one or more aspects of the present disclosure.

FIG. 10 shows a block diagram of a communications manager that supports OAM multiplexing using multiple modes in an antenna array in accordance with one or more aspects of the present disclosure.

FIG. 11 shows a diagram of a system including a UE that supports OAM multiplexing using multiple modes in an antenna array in accordance with one or more aspects of the present disclosure.

FIG. 12 shows a diagram of a system including a network entity that supports OAM multiplexing using multiple modes in an antenna array in accordance with one or more aspects of the present disclosure.

FIGS. 13 through 16 show flowcharts illustrating methods that support OAM multiplexing using multiple modes in an antenna array in accordance with one or more aspects of the present disclosure.

### DETAILED DESCRIPTION

In some wireless communications systems, wireless devices, such as base stations, user equipments (UEs), network nodes, or any combination thereof, may communicate directionally, for example, using beams to orient communication signals over one or more directions. Various wireless communication schemes, such as line-of-site multiple-input multiple-output (LoS-MIMO), are being considered for advanced wireless communication systems (e.g., sixth generation (6G)) wireless communication systems) to, for example, support high throughput over short distances. In such environments, two network nodes or other devices may communicate using one or more antenna arrays. For example, the devices may support orbital angular momentum (OAM) multiplexing, in which a first device, which may be referred to as a transmitting device, and a second device, which may be referred to as a receiving device, may each be equipped with antenna arrays disposed in a circle (e.g., a transmitter circle and a receiver circle, respectively). As used herein, a transmitter circle or receiver circle may refer to a circular arrangement of antenna elements configured to support OAM multiplexing, and the antenna elements of the transmitter circle or receiver circle may or may not be disposed in a perfect circle. The transmitter circle, the receiver circle, or both, may alternatively be referred to as a circular antenna array.

The transmitter and receiver circles may be supportive of communication between the devices according to one or more OAM modes. Each OAM mode may correspond to a respective vector of OAM weights (e.g., an OAM weighting vector) to be applied to the antenna elements of the transmitter and receiver circles to generate and decode signals, respectively. In some cases, the transmitter and receiver circles may communicate signals according to a single OAM mode between the respective circular antenna arrays. However, utilizing a single OAM mode for communications between the respective circular antenna arrays may limit overall throughput of data in a wireless communications network. In other cases, the transmitter and receiver circles may communicate signals in accordance with multiple OAM modes by utilizing all antenna elements of the respective circular antenna arrays to support the multiple OAM modes. However, utilizing all antenna elements of the respective circular antenna arrays to support the multiple OAM modes may result in an unequal power distribution, and thus, the need for multiple power amplifiers at one or both network nodes.

Techniques described herein provide for configurations supporting OAM communications between a first device and a second device using multiple OAM modes in a single circular antenna array at one or both devices. A first circular antenna array at a first device may contain multiple subsets of a first quantity of equally spaced antenna elements in a circle, wherein each subset may be associated with an OAM mode of the multiple OAM modes. For example, a first device may generate multiple signals for transmission from the first device to a second device via a first circular antenna array. The first device may transmit a first signal of the multiple signals using a first OAM mode and a first subset of the first circular antenna array. Additionally, the first device may transmit a second signal of the multiple signals using a second OAM mode and a second subset of the first circular antenna array, wherein the first subset and the second subset are different. In some cases, the first subset and the second subset are exclusive of one another.

In some examples, first circular antenna array may be composed of a first quantity of antenna elements disposed in a circle (e.g., 8 antenna elements in a circle). The first quantity of antenna elements may be segmented into a first subset of the first quantity of antenna elements (e.g., such that one in every two antenna elements of the first quantity of elements belong in the first subset) and a second subset of the first quantity of antenna elements (e.g., such that the remaining antenna elements of the first quantity of elements belong in the second subset), wherein the first subset may be associated with a first OAM azimuth mode and the second subset may be associated with a second OAM azimuth mode. Upon receiving the first signal and the second signal transmitted by the first device, the second device may decode the first signal and second signal using respective sets of antenna elements.

In some aspects, these device (e.g., network nodes) may apply these multiplexing schemes to multiple circles of antenna elements, such that each circle supports multiple OAM modes based on segmentation of the antenna elements into two or more subsets. The multiple circles of antenna elements disposed in the antenna array may be concentric. For example, a first circular antenna array may contain a first quantity of antenna elements in a first circle and a second quantity of antenna elements in a second circle which is concentric with the first circle. Additionally or alternatively, the first device may transmit a first signal using a first subset of the first quantity of antenna elements, a second signal using a second subset of the first quantity of antenna elements, a third signal using a first subset of the second quantity of antenna elements, and a fourth signal using a second subset of the second quantity of antenna elements, such that each subset supports a different OAM mode.

Particular implementations of the subject matter described in this disclosure can be implemented to realize one or more of the following potential advantages. For example, devices which support OAM multiplexing by utilizing multiple OAM modes in a single circular antenna array provide higher degrees-of-freedom gain at the cost of a lower array gain, resulting in a throughput gain at high signal to noise ratio (SNR). As a result, such devices may increase the overall throughput in a wireless communications network, enabling low latency wireless communications. Also, devices which utilize multiple OAM modes in a single circular antenna array may contribute to improved resource utilization and, accordingly, resource savings in a wireless communications. Further, the techniques described herein may reduce power consumption by reducing the amount of power amplifiers at the devices. For example, if each subset of a quantity of antenna elements disposed in a circular antenna array may be associated with a single OAM mode, one power amplifier may be needed per OAM mode instead of one power amplifier per antenna element. Further, if multiple OAM modes in a single circular antenna array have the same power, then a single power amplifier may be sufficient for the circular antenna array containing the multiple OAM modes.

Aspects of the disclosure are initially described in the context of wireless communications systems. Additional aspects of the disclosure are described with reference to OAM antenna array configurations and process flows. Aspects of the disclosure are further illustrated by and described with reference to apparatus diagrams, system diagrams, and flowcharts that relate to orbital angular momentum multiplexing using multiple modes in an antenna array.

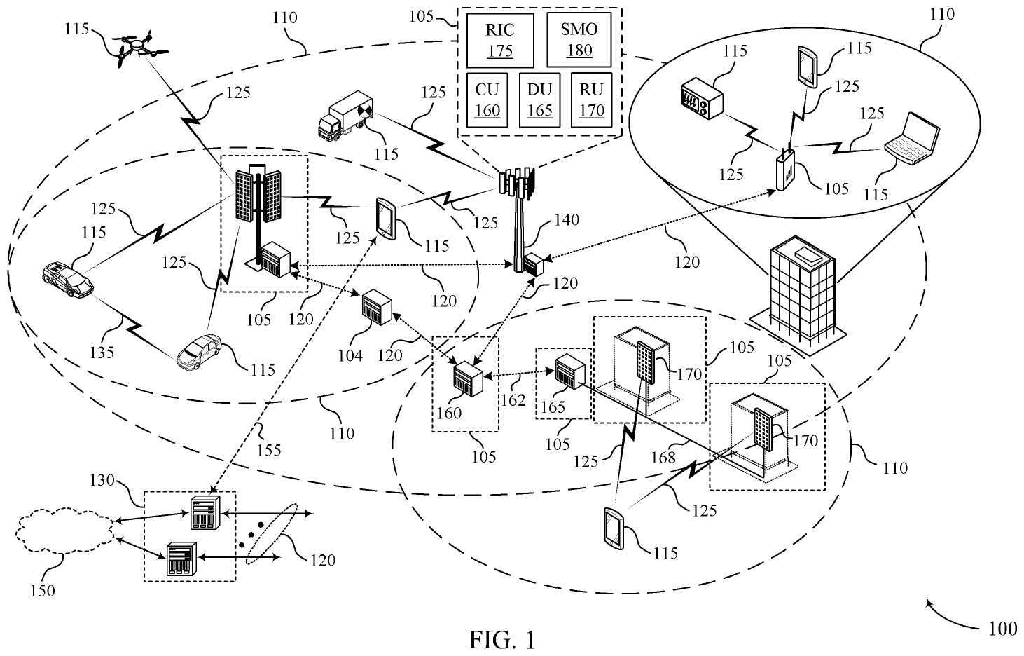

FIG. 1 illustrates an example of a wireless communications system 100 that supports OAM multiplexing using multiple modes in an antenna array in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support OAM multiplexing using multiple modes in an antenna array as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some aspects, one or more devices in the wireless communications system 100, such as a UE 115, a base station 105, an IAB node 104, an RU 170, a DU 165, a CU 160, or any combination thereof, may support OAM communications. A device that supports OAM communication may include a circular array including multiple antenna elements, which may be referred to as a transmitter circle and/or a receiver circle. Additionally or alternatively, the device may include a circular array including multiple antenna subarrays, wherein each antenna subarray may include one or more antenna elements. The devices may include a quantity of antenna elements disposed in a circle, which may be referred to as a transmitter circle and/or a receiver circle. In some example, a transmitting device may generate one or more OAM signals for transmission to a receiving device via the transmitter circle. Additionally, the transmitting device may transmit the one or more OAM signals to the receiving device using the transmitter circle and one or more OAM modes so that the generated signals may be orthogonally received and decoded at the receiving device.

In some examples, devices may support beamforming for OAM communications by utilizing phase-only modulators at each antenna element in the transmitter circle and in the receiver circle in order to limit the number of power amplifiers at either device, as power amplifiers may be more expensive than phase-only modulators. Accordingly, such devices may be limited to supporting one single OAM mode per circle of antenna elements, resulting in constraints in the throughput, capacity, and spectral efficiency of wireless communications between the devices. In some examples, devices may support beamforming for OAM communications in accordance with multiple OAM modes in a circle by utilizing all antenna elements in the transmitter circle and/or in the receiver circle for all of the multiple OAM modes. However, such devices may experience unequal power levels amongst the antenna elements in either circle, and thus, may require multiple power amplifiers for either circle (e.g., one power amplifier per antenna element).

The techniques described herein provide for a node that supports transmissions and receptions using multiple modes in a single circle of antenna elements. A first device (a UE 115, a base station 105, an IAB node 104, an RU 170, a DU 165, a CU 160, or any combination thereof), which may be referred to as a transmitting device in this example, may generate a plurality of signals for transmission by utilizing a first circular antenna array containing a first quantity of antennas disposed in a circle. The first device may transmit a first signal of the generated signals by using a first OAM mode that may be associated with a first subset of the first quantity of antenna elements disposed in the circle. Additionally, the first device may transmit a second signal of the generated signals by using a second OAM mode that may be associated with a second subset of the first quantity of antenna elements disposed in the circle. The first quantity of antenna elements may be segmented into a first subset and a second subset of antenna elements in an alternating pattern. The first subset and the second subset may be exclusive of one another. Thus, using these techniques, one power amplifier may be configured per OAM mode instead of one power amplifier per antenna element. Further, if multiple OAM modes in a single circular antenna array have the same power, then a single power amplifier may be sufficient for the circular antenna array containing the multiple OAM modes. Accordingly, these techniques may support increased throughput using multiple OAM modes per antenna circle while reducing power consumption via fewer power amplifiers.

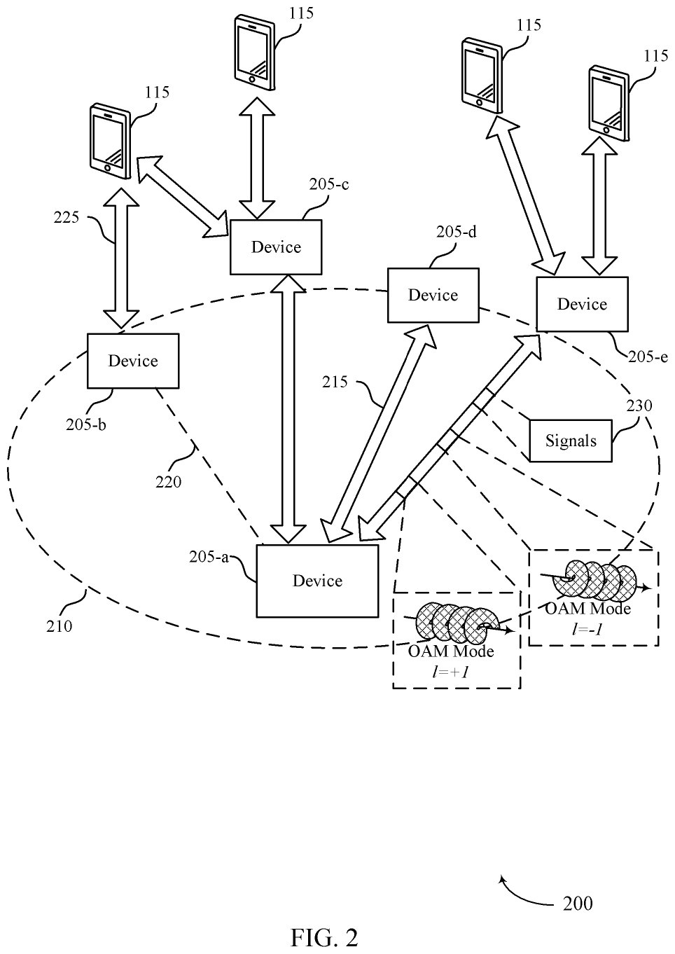

FIG. 2 illustrates an example of a wireless communications system 200 that supports OAM multiplexing using multiple modes in an antenna array in accordance with one or more aspects of the present disclosure. The wireless communications system 200 may implement or be implemented by aspects of the wireless communications system 100. The wireless communications system may include one or more devices 205 and UEs 115. The devices 205 may each be an example of a UE 115, a base station 105, an IAB node, a CU, a DU, an RU, or any other wired or wireless device. In some aspects, the devices 205-a, 205-b, 205-c, 205-d, and 205-e may form a network device architecture 210, which may be used to relay signals from a radio access network (RAN) (e.g., using smart coordination) to the UEs 115 or other wireless access devices. The wireless communications system 200 (which may be an example of a 6G system, a 5G system, or another generation system) may support OAM-based communications and, as such, the devices 205 the one or more UEs 115, or both may transmit or receive OAM beams, or OAM-related signals over respective communication links.

The device 205-a may represent an example of a core unit of the network device architecture 210, such as a base station 105, a RAN CU, a RAN DU, or some other network node. In some cases, the device 205-a may be connected with the other devices 205 via wired fronthaul/backhaul communication links 220 (e.g., fiber-based fronthaul). Additionally or alternatively, the device 205-a may communicate with one or more other devices 205 of the network device architecture 210 via wireless fronthaul/backhaul communication links 215. The wireless fronthaul/backhaul communication links 215 may reduce cost and deployment complexity as compared with the wired fronthaul/backhaul communication links 220. The other devices 205 may represent aspects of distributed network nodes, such as IAB nodes, repeaters, RUs, or any combination thereof that may relay signals from the RAN to one or more UEs 115 or other wireless devices via wireless access communication links 225.

The wireless communications system 200 may support various communications schemes, such as LoS-MIMO. In such environments, a direct link may be present between two or more devices 205 (e.g., without a physical obstruction). For example, the network device architecture 210 may occupy a relatively small area, such that a distance between the devices 205 is relatively short. The devices 205 may communicate according to one or more LoS-MIMO communication schemes using one or more antenna subarrays based on the relatively small distance between devices. Such LoS-MIMO communication schemes may support relatively high throughput and data capacities over relatively short distances. As such, LoS-MIMO may provide for the wireless fronthaul/backhaul communication links 215 to support sufficient data capacity between devices 205 of the network device architecture 210 without deploying physical fibers or cables. For example, the device 205-a (e.g., a DU or core network node) may be deployed with an aperture array that connects with one or more other devices 205 (e.g., instead of fibers). In some aspects, the performance of the aperture array on the device 205-a may be improved between the device 205-a and the other devices 205-c, 205-d, and 205-e to support relatively high throughput and capacity of the wireless fronthaul/backhaul communication links 215.

OAM-based communications may be an example of a LOS-MIMO communication scheme supported by the wireless communications system 200. Each of the devices 205, the UEs 115, or both may support OAM communication and may include an OAM antenna system having multiple antenna elements or antenna subarrays arranged in one or more concentric circular arrays. The respective antenna subarrays of the devices 205 may be installed or dynamically adjusted such that they are aligned along a first axis (e.g., a horizontal or vertical axis) as well as rotationally, or such that they are offset by a configured rotational offset. OAM communication may support relatively high-order spatial multiplexing, and in some aspects, the offsets between antenna subarrays may be configured to improve orthogonality between signals and data throughput. OAM communication may support relatively high data rates between two or more devices 205 over relatively short distances. In some aspects, the devices 205 may perform OAM communications in relatively high frequency spectrums (e.g., sub-THz, THz, etc.). Although OAM communication is described in the context of fronthaul and backhaul, it is to be understood that the communication techniques described herein may be applicable to any two wireless devices, include access devices (e.g., UEs, CPEs), network devices (e.g., base stations, DUs, CUs, RUs, IAB nodes), or both.

The devices 205 may support OAM-based communication by using OAM of electromagnetic waves to distinguish between different signals. For example, a transmitting device 205 may radiate multiple coaxially propagating, spatially-overlapping waves each carrying a data stream through an array of apertures. In some cases, the OAM of the electromagnetic wave may be associated with a field spatial distribution of the electromagnetic wave, which may be in the form of a helical or twisted wavefront shape. For example, an electromagnetic wave may correspond to a helical transverse phase of the form exp (iφl) may carry an OAM mode waveform, where φ may be an azimuthal angle of the waveform and l may be an unbounded integer, which may be referred to as an OAM order, a helical mode, or an OAM mode. Each OAM mode (e.g., OAM modes l= . . . , −2,−1,0,1,2, . . . ) may be orthogonal.

Such OAM modes may be characterized by a wavefront that is shaped as a helix with an optical vortex in the center (e.g., at the beam axis), where each OAM mode is associated with a different helical wavefront structure. The OAM modes may be defined or referred to by the mode index l, where a sign of the mode index l corresponds to a “handedness” (e.g., left or right) of the helix (or helices) and a magnitude of the mode index l (e.g., |l|) corresponds to a quantity of distinct but interleaved helices of the electromagnetic wave.

For example, for an electromagnetic wave associated with an OAM mode index of l=0, the electromagnetic wave may not be helical and the wavefronts of the electromagnetic wave are multiple disconnected surfaces (e.g., the electromagnetic wave is a sequence of parallel planes). For an electromagnetic wave associated with an OAM mode index of l=+1, the electromagnetic wave may propagate in a right-handed pattern (e.g., has a right circular polarization or may be understood as having a clockwise circular polarization) and the wavefront of the electromagnetic wave may be shaped as a single helical surface with a step length equal to a wavelength A of the electromagnetic wave. An example of such an electromagnetic wave is illustrated in FIG. 2. Similarly, for an OAM mode index of l=−1, the electromagnetic wave may propagate in a left-handed pattern (e.g., has a left circular polarization or may be understood as having a counter-clockwise circular polarization) and the wavefront of the electromagnetic wave may also be shaped as a single helical surface with a step length equal to the wavelength/of the electromagnetic wave.

For further example, for an OAM mode index of l=±2, the electromagnetic wave may propagate in either a right-handed pattern (if +2) or in a left-handed pattern (if −2) and the wavefront of the electromagnetic wave may include two distinct but interleaved helical surfaces. In such aspects, the step length of each helical surface may be equal to λ/2. Likewise, the phase delay over one revolution of the electromagnetic wave may be equal to +4π. In general terms, a mode-l electromagnetic wave may propagate in either a right-handed pattern or a left-handed pattern (depending on the sign of l) and may include l distinct but interleaved helical surfaces with a step length of each helical surface equal to λ/|l|. In some aspects, an electromagnetic wave may be indefinitely extended to provide for an infinite number of degrees of freedom of the OAM of the electromagnetic wave (e.g., l=0, ±1, ±2, . . . , ±∞). As such, the OAM of the electromagnetic wave may be associated with infinite degrees of freedom.

In some aspects, the OAM mode index l of an electromagnetic wave may correspond to or otherwise function as (e.g., be defined as) an additional dimension for signal or channel multiplexing. For example, each OAM mode, which may correspond to an OAM state (of which there may be infinite), may function similarly (e.g., or equivalently) to a communication channel, such as a sub-channel. In other words, an OAM mode or state may correspond to a communication channel, and vice versa. For instance, the devices 205 may communicate separate signals 230 using electromagnetic waves having different OAM modes or states similarly to how the devices may transmit separate signals over different communication channels. In some aspects, such use of the OAM modes or states of an electromagnetic wave to carry different signals 230 may be referred to as the use of OAM beams.

Such OAM waveforms associated with different OAM modes may be orthogonally received at a same time and frequency radio resource, which may improve communication spectrum efficiency with relatively low processing complexity at a receiving device 205. For example, a transmitting device 205, such as the device 205-a, may transmit one or more signals 230 to a receiving device 205, such as the device 205-e, using multiple OAM modes. Each signal 230 may be transmitted according to a respective OAM mode, such that the signals 230 do not overlap or interfere with each other. In some aspects, two or more signals 230 may be transmitted concurrently. Additionally or alternatively, two or more signals 230 may be transmitted simultaneously. If polarizations are added to the OAM modes, a quantity of orthogonal OAM streams may increase.

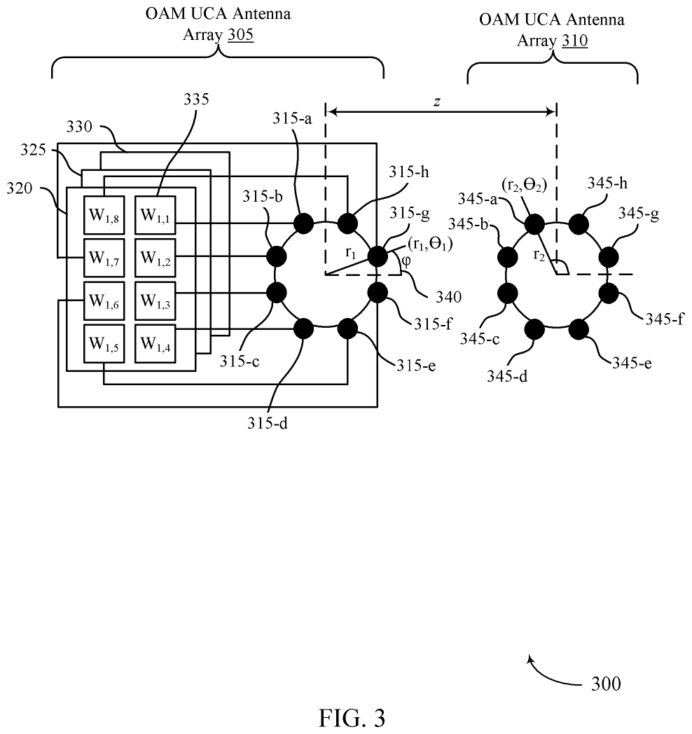

To support such OAM communication, each device 205 may be configured with a set of antenna subarrays configured in a circular shape, such as a uniform circular array (UCA) antenna circle (e.g., an antenna circle, a transmitter circle, or a receiver circle). Each device 205 may be equipped with one or more UCA circles that the device 205 may use to communicate the signals 230 according to one or more OAM modes. The OAM antenna array configurations are described in further detail elsewhere herein, including with reference to FIGS. 3-6.

In some cases, the transmitting device 205-a and the receiving device 205-e may be configured with a same quantity of antenna subarrays or antenna elements at each device 205. A quantity of OAM modes that can be generated by each device 205 may correspond to the quantity of antenna subarrays. For example, if a device 205 has N antenna subarrays, the device 205 may be configured to generate N OAM modes. Each OAM mode may correspond to a set of OAM weights (e.g., an OAM weighting vector) to be applied to the antenna subarrays of the transmitting device 205-a when generating the transmission. The receiving device 205-e may utilize the OAM modes corresponding to the quantity of antenna subarrays to identify weights applied by the transmitting device 205-a to the OAM signals. The receiving device 205-e may receive and decode the OAM signals based on the weights.

In some examples, the devices 205 may communicate the signals 230 using multiple modes in a single transmitter circle or receiver circle, respectfully, by utilizing antenna elements in a circle to support OAM communications in accordance with the multiple modes associated with the signals 230. For example, the transmitting device 205-a may transmit a first signal using a first OAM mode via the antenna elements in a transmitter circle and also transmit a second signal using a second OAM mode via the antenna elements in the transmitter circle. However, if the device 205-a transmits the signals 230 by using all of the antenna elements in the transmitter circle to communicate with the multiple OAM modes, then the device 205-a may experience unequal power distribution amongst the antenna elements, resulting in a need for as many as one power amplifier per antenna element.

As described herein, the devices 205 may be configured with methods for supporting OAM communications using multiple modes in an antenna array. For example, the transmitting device 205-a may generate a plurality of signals (e.g., the signals 230) by using a quantity of antenna elements disposed in a circle. The transmitting device 205-a may transmit a first signal of the signals 230 by using a first OAM mode and a first subset of the quantity of antenna elements in the circle. Additionally, the transmitting device 205-a may transmit a second signal of the signals 230 by using a second OAM mode and a second subset of the quantity of antenna elements in the same circle. The segmented subsets of the quantity of antenna elements in the circle may be exclusive to one another, in that the transmitting device 205-a may transmit the first signal using the first OAM mode by utilizing antenna elements of the first subset and transmit the transmit the second signal using the second OAM mode by utilizing antenna elements of the second subset. In some aspects, the first signal may include a first set of reference signals, and the second signal may include a second set of reference signals.

The devices 205 may be equipped with a phasor (e.g., a phase shifter, a phase modulator) at each antenna element in the transmitter circle and the receiver circle, respectively. Additionally or alternatively, the transmitter circle and receiver circle at the devices 205 may be equipped with one power amplifier per OAM mode used to communicate the signals 230. In some examples, a first power amplifier may be associated with a first OAM mode and a first subset of a quantity of antenna elements in a circle, and a second power amplifier may be associated with a second OAM mode and a second subset of a quantity of antenna elements in the same circle. Accordingly, the transmitting device 205-a may transmit the first signal via the first subset using a first power applied by the first power amplifier. Additionally or alternatively, the transmitting device 205-a may transmit the second signal via the second subset using a second power applied by the second power amplifier. In some aspects, if multiple OAM modes have the same amount of power, then the devices 205 may support OAM communications using a single power amplifier for a transmitter circle or a receiver circle. Power amplifiers may be more expensive than phase shifters. Accordingly, the devices 205 may support cost-efficient OAM communications by using one power amplifier per subset of antenna elements disposed in a circle or one power amplifier per circle of antenna elements, rather than using one power amplifier per individual antenna element disposed in a circle.

In some examples, the devices 205 may exchange signaling to indicate the capability of the devices to transmit a plurality of signals using a multimode transmission mode. For example, the transmitting device 205-a may transmit a capability message to the receiving device 205-e to specify that the transmitting device 205-a may transmit the signals 230 to the receiving device 205-e, one or more other devices 205 (e.g., via a broadcast message), or both, using a multimode transmission mode in one circular antenna array (e.g., the transmitter circle), which may include a first OAM mode using a first subset of antenna elements in the transmitter circle and a second OAM mode using a second subset of antenna elements in the transmitter circle. The signaling may be control signaling, such as RRC signaling, system broadcast signaling, another type of control signaling (e.g., downlink control information (DCI), uplink control information (UCI), sidelink control information (SCI), MAC layer control element (MAC-CE)), or any combination thereof configured to indicate the capability to transmitting signals using the multimode transmission mode. In some aspects, the signaling may be transmitted semi-statically (e.g., an RRC configuration). Additionally or alternatively, the devices 205 may dynamically transmit the signaling.

In some examples, the devices 205 may exchange additional signaling in the form of a feedback message to indicate whether the devices 205 are to use the multimode transmission mode or a single mode transmission mode. For example, the transmitting device 205-a may receive a feedback message from the receiving device 205-e. By transmitting the feedback message, the receiving device 205-e may indicate that the transmitting device 205-a may use the multimode transmission mode from among the options of the single mode transmission mode and the multimode transmission mode. Similar to the signaling used for the capability message, the signaling for the feedback message may be RRC signaling, a system broadcast signal, another type of control signaling, or any combination thereof configured to indicate a request to use the multimode transmission mode or a single mode transmission mode.

In some examples, the devices 205 may communicate sets of reference signals. For example, the transmitting device 205-a may transmit a first set of reference signals using the first OAM mode, and the transmitting device 205-a may transmit a second set of references signals using the second OAM mode. In some examples, the transmitting device 205-a may transmit reference signals from each transmitter antenna element in a circular antenna array, wherein each antenna element may be identifiable, or each antenna set in the circle is identifiable. In some examples, the receiving device 205-b may perform channel quality measurements by measuring a channel response matrix, either element-by-element if each transmitter antenna element is identifiable, element-by-modes, mode-by-element, or mode-by-mode. Based on transmitting the first set and the second set of reference signals, the devices 205 may receive a feedback message which may indicate channel quality indications corresponding to the antenna elements in OAM modes used for transmission of the sets of reference signals. In some aspects, the feedback message may include channel quality measurements. In other aspects, the feedback message may include mode-by-mode channel quality in order to reduce signaling overhead.

For example, the transmitting device 205-a may receive a feedback message that includes one or more channel quality indicators which correspond to each antenna element of the quantity of antenna elements disposed in the transmitter circle, each mode of the first OAM mode and the second OAM mode, or both. By receiving the feedback message containing the channel quality indications in response to transmitting the sets of reference signals, the transmitting device 205-a may adjust various transmission characteristics based on the channel quality or qualities indicated in the feedback messages. In some aspects, the devices 205 may communicate subsequent signaling using one or more of the multiple OAM modes based on the one or more channel quality indications. For example, based on receiving the channel quality indications, the transmitting device 205-a may transmit one or more subsequent signals using the first OAM mode, the second OAM mode, both the first and the second OAM mode, or using another mode (e.g., using a OAM mode configured using the antenna elements of the circle).

In some aspects, the devices 205 may exchange signaling to indicate or report topologies of the circular antenna arrays at the devices 205. By indicating the topology of the circular antenna arrays involved in OAM communications, the devices 205 may be aware of certain properties of the antenna arrays used for communicating the signals 230. For example, the transmitting device 205-a may transmit an indication of a topology information for the circular antenna array, and the topology information may include information such as a number of circles of antenna elements in the circular antenna array, a quantity of antenna elements in each of the one or more circles, a quantity of power amplifiers for the one or more circles, a quantity of digital beamformers for the one or more circles, or a combination thereof. In some examples, the topology information may include power amplifier chain information, such as the quantity of power amplifiers per circle, to facilitate OAM multiplexing schemes. Additionally or alternatively, the transmitting device 205-a may receive an indication of a topology (e.g., topology information) of a second circular antenna array respective to the receiving device 205-e, where the topology may include details such as a number of circles of antenna elements in the second circular antenna array, a quantity of antenna elements in each of the one or more circles, a quantity of power amplifiers for the one or more circles, a quantity of digital beamformers for the one or more circles, or a combination thereof. In some examples, the devices 205 (e.g., the transmitting device 205-a) may transmit a first signal using a first OAM mode and a second signal using a second OAM mode based on the topology of the first circular antenna array, the topology of the second circular antenna array, or a combination thereof.

FIG. 3 illustrates an example of an OAM antenna array configuration 300 that supports OAM multiplexing using multiple modes in an antenna array in accordance with one or more aspects of the present disclosure. In some aspects, the OAM antenna array configuration 300 may implement aspects of wireless communications systems 100 or 200. In this example, a transmitting device (e.g., a UE, a base station, an RU, a DU, a CU, an IAB node or some other device) may include an OAM UCA antenna array 305 and a receiving device (e.g., a UE, a base station, an RU, a DU, a CU, an IAB node or some other device) may include an OAM UCA antenna array 310.

In some aspects, one or both of the OAM UCA antenna array 305 or the OAM UCA antenna array 310 may be implemented as a planar array of antenna elements, or individual antenna arrays or subarrays, which may be an example of or otherwise function as a (massive or holographic) MIMO array or an intelligent surface. In some cases, the transmitting device may identify a set of antenna subarrays 315 (e.g., an antenna element) of the planar array that form a UCA (e.g., transmitter antenna subarrays 315-a, 315-b, 315-c, 315-d, 315-e, 315-f, 315-g, and 315-h), and a receiving device may identify a set of antenna subarrays 345 of the planar array that form a UCA (e.g., receiver antenna subarrays 345-a, 345-b, 345-c, 345-d, 345-e, 345-f, 345-g, and 345-h). In some aspects, the set of antenna subarrays 315 at the transmitting device may be evenly equipped in a first circle, and the set of antenna subarrays 345 at the receiving device may be evenly equipped in a second circle that is located a distance z from the first circle. In some examples, the antenna subarrays 315 (e.g., antenna elements) may be individual antennas instead of subarrays.

Upon selecting the set of antenna subarrays from the planar array, the transmitting device may apply a beamforming weight 335 to each of the selected antenna subarrays 315 based on the OAM mode index l of the transmitted OAM beam and one or more spatial parameters associated with each antenna subarray 315. In cases in which a UCA methodology is used to generate an OAM beam, the transmitting device may identify the set of antenna subarrays 315 on a circular array of antenna elements and may apply a first set of weights 320 to each of the identified antenna subarrays 315 based on a first OAM mode index (e.g., l=0). Further, for other OAM mode indices, other weights may be used for the set of antenna subarrays 315, such as a second OAM mode index (e.g., l=+1) that may use a second set of weights 325 and a third OAM mode index (e.g., l=−1) that may use a third set of weights 330. Each OAM mode may be characterized by a different helical wave structure, as described with reference to FIG. 2. The helical wave structure for each mode may be generated by applying the respective set of weights to the antenna subarrays 315 of the transmitting device.

For example, to generate an OAM beam with an OAM mode index (e.g., l=0), the transmitting device may apply a weight 335 to each antenna subarray 315 on the UCA based on an angle 340 measured between a reference line on the UCA (e.g., the x-axis of the plane on which the UCA is located, where the origin is at the center of the UCA) and the antenna subarray 315, the OAM mode index l, and i (e.g., for complex-valued weights, which may alternatively be denoted as j in some cases). In some cases, for instance, the weight for an antenna element n may be proportional to e^{i*l*φ}^{ₙ}, where φₙ is equal to the angle 340 measured between the reference line on the UCA and the antenna element n. By multiplying respective beamforming weights 335 of each set of weights 320-330 (e.g., for first set of weights 320, w₁= [w_{1,1}, w_{1,2}, . . . , w_{1,8}]^{T}) onto each antenna subarray 315, a signal port may be generated. If the weight 335 of each antenna subarray 315 is equal to e^{iφl}, where φ is the angle of an antenna subarray 315 in the circle (e.g., angle 340 for antenna subarray 315-g), and l is the OAM mode index, then each set of weights 320-330 provides a beamformed port that is equivalent to OAM mode l. By using different beamforming weights e^{iφl′}, where l′≠l, multiple OAM modes are thus generated.

In some examples, the transmitting device may apply respective beamforming weights 335 of each set of weights 320-330 (e.g., for first set of weights 320, w₁=[w_{1,1}, w_{1,2}, . . . , w_{1,8}]^{T}) for transmission of a plurality of signals using a quantity of phasors (e.g., phase-only modulators, phase shifters) which correspond to a quantity of respective antenna elements. For example, the transmitting device may transmit a first signal associated with a first OAM mode and transmit a second signal associated with a second OAM mode using a first quantity of phasors, wherein each phasor of the quantity of phasors may correspond to a respective antenna element in the circle (e.g., an antenna subarray 315). Accordingly, the transmitting device may use the quantity of phasors to apply the respective beamforming weights 335 of each set of weights 320-330 to the respective antenna subarrays 315.

In some aspects, the OAM UCA antenna arrays 305 and 310 may support OAM-based communications which achieve a high-level spatial multiplexing degree efficiently based on the orthogonality of OAM weighting vectors. At the OAM UCA antenna arrays 310, the receiving device may have receiver antenna subarrays 345 equipped in a circle. The channel matrix may be denoted from each transmitter antenna subarray 315 to each receiver antenna subarray 345 as H, and then for the beamformed channel matrix \tilde{H}=H·[w₁, w₂, . . . , w_{L}]. Any two OAM weighting vectors of [w₁, w₂, . . . , w_{L}] may be orthogonal relative to each other. Accordingly, OAM channels represented by the beamformed channel matrix may have no crosstalk.

It is to be understood that antenna arrays including multiple antenna subarrays described herein may alternatively be referred to as transmitter circles or receiver circles. Further, the same circular antenna array may at times act as a transmitter circle and may at times act as a receiver circle, but may be referred to as one or the other for the sake of clarity in related descriptions. It is to be understood that any signaling described as received by a device having a transmitter circle could be received via the transmitter circle or via another antenna array, antenna subarray, or antenna element at the device (e.g., a separate receiver circle at the device or some other antenna array or element at the device). Similarly, any signaling described as transmitted by a device having a receiver circle could be transmitted via the receiver circle or via another antenna array, antenna subarray, or antenna element at the device (e.g., a separate transmitter circle at the device or some other antenna array or element at the device). Additionally, though referred to herein as transmitter antenna subarrays 315 and receiver antenna subarrays 345, it is to be understood that these aspects may alternatively be referred to as transmit antenna arrays and receive antenna arrays, each of which may include multiple antenna elements.

As described herein, to support increased throughput, the OAM UCA antenna arrays 305 and 310 may support multiple OAM modes using the same circular antenna array by partitioning the antenna subarrays into subsets of antenna elements. For example, the device supporting OAM UCA antenna array 305 may partition the antenna subarrays 315-a through 315-h into two subsets of antenna subarrays (e.g., two subsets of antenna elements). Each antenna subarray 315 of OAM UCA antenna array 305 may be partitioned in the first subset or the second subset in an alternating pattern as the antenna subarrays of the circle are traversed. The device may transmit a first signal using a first OAM mode and the first subset of antenna subarrays 315 and a second signal using a second OAM mode of the second subset of antenna subarrays 315. As described in further detail herein, the devices may exchange signaling to indicate support and/or preference of using multi-OAM mode transmission in single circle. Additionally or alternatively, signaling may be used to indicate topology (e.g., multiple circles, multiple modes per circle, PA chains) to other devices. Further, reference signal transmission and feedback may be used to support determination of channel characteristics by a transmitting and/or receiving device that support multiple OAM modes in a single circular antenna array.

As described herein, the transmitting device and the receiving device may utilize feedback information to perform OAM beamforming and determine beamforming vectors to use for communicating when OAM multiplexing is performed using multiple modes in an antenna array. The transmitting device may transmit one or more reference signals to the receiving device. The receiving device may perform a channel estimation procedure based on the one or more reference signals, which may be CSI reference signals, SRSs, or other types of reference signals. In some aspects, the channel estimation procedure may be performed by the transmitting device, the receiving device, or both. The channel estimation may be performed regardless of whether the antenna subarray quantities are the same or different.

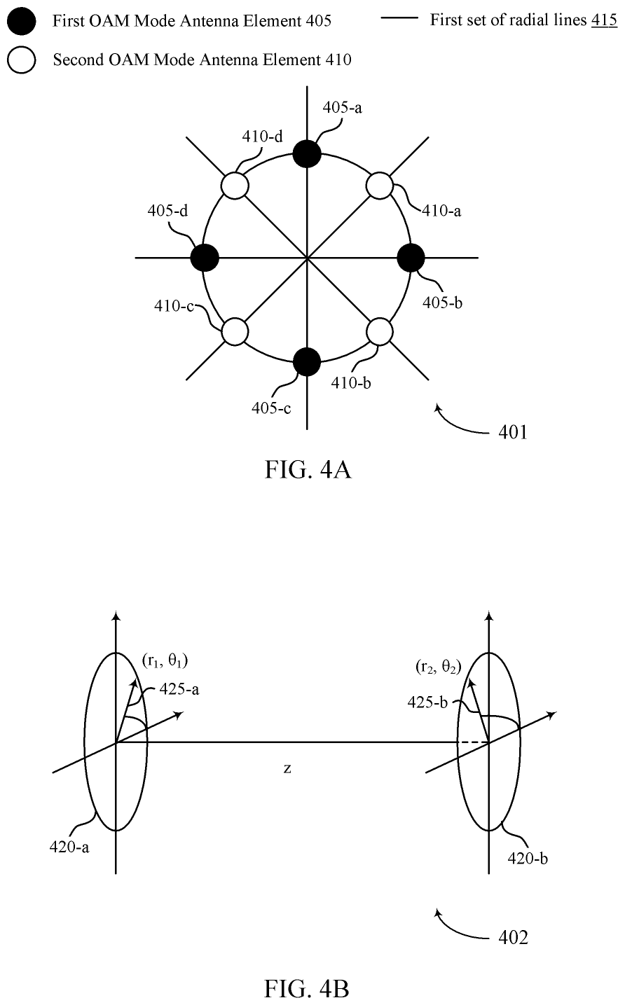

FIG. 4A and FIG. 4B illustrate an example of OAM antenna array configurations 401 and 402 that support OAM multiplexing using multiple modes in an antenna array in accordance with one or more aspects of the present disclosure. The OAM antenna array configurations 401 and 402 may implement or be implemented by aspects of the wireless communications system 200 or the OAM antenna array configuration 300. For example, the OAM antenna array configuration 401 illustrates a configuration of antenna elements at a transmitting device, a receiving device, or both. The transmitting and receiving devices may represent aspects of corresponding devices as described with reference to FIGS. 1-3 (e.g., a UE, a base station, a CU, a DU, an RU, an IAB node, or any other device).

FIG. 4A illustrates an OAM antenna array configuration 401 that may be an example of a first circular antenna array that uses a first OAM mode and a second OAM mode. In this example, the transmitting device may include the first circular antenna array which contains a first quantity of antenna elements disposed in a circle. The first quantity of antenna elements includes first OAM mode antenna elements 405 (e.g., a first subset of the first quantity of antenna elements) and second OAM mode antenna elements 410 (e.g., a second subset of the first quantity of antenna elements). Similarly, a receiving device may include a first circular antenna array that contains a first quantity of antenna elements disposed in a circle. The first quantity of antenna elements includes the first OAM mode antenna elements 405 and the OAM mode antenna elements 410. In the example of FIG. 4A, the transmitting device, the receiving device, or both may include four first OAM mode antenna elements 405 and four second OAM mode antenna elements 410. However, it is to be understood that the transmitting and receiving devices may include any quantity of antenna elements. In some examples, multiple circles, each with a smaller number of antenna elements, may be used for transmission or reception at a device. In some aspects, the antenna elements of the OAM mode antenna elements 405 and of the second OAM mode antenna elements 410 may be positioned in the circle such that the antenna elements are equally spaced apart. A first set of radial lines 415 are includes for illustrative purposes to show positioning of the antenna elements.

Because each subset of a quantity of antenna elements disposed in a circular antenna array may be associated with a single OAM mode, each antenna element belonging in an OAM mode-specific subset of the quantity of antenna elements may have equal and constant power. Accordingly, one power amplifier may be used per OAM mode instead of one power amplifier per antenna element. In the example of the OAM antenna array configuration 401, a first power amplifier may be used for the first OAM mode antenna elements 405, and a second power amplifier may be used for the second OAM mode antenna elements 410. Further, if multiple OAM modes in a single circular antenna array have the same power, then a single power amplifier may be sufficient for the circular antenna array containing the multiple OAM modes. For example, if the first OAM mode antenna elements 405 and the second OAM mode antenna elements 410 have the same power, then a single power amplifier may be used for the first OAM mode antenna elements 405 and the second OAM mode antenna elements 410. By using one power amplifier per subset of antenna elements disposed in a circle or one power amplifier per circle of antenna elements, rather than using one power amplifier per individual antenna element disposed in a circle, the OAM antenna array configuration 401 may reduce the number of power amplifiers required for OAM communications in a transmitting and/or receiving device. Each antenna elements in the OAM antenna array configuration 401 may use analogue (or digital) phasor to perform beamforming, adding little or no additional complexity in design compared to OAM antenna array configurations which may use one OAM mode per circle.

In the OAM antenna array configuration 401, the first circular antenna array may split the quantity of antenna elements disposed in the circle into multiple OAM mode-specific subsets of the quantity of antenna elements in an alternating pattern of antenna elements associated with either of the OAM modes. For example, the first OAM mode antenna elements 405-a, 405-b, 405-c, and 405-d may be included in a first subset of the quantity of antenna elements that may be associated with the first OAM mode. Additionally or alternatively, the second OAM mode antenna elements 410-a, 410-b, 410-c, and 410-d may be associated with the second OAM mode. The first OAM mode antenna elements 405 may be exclusive of the second OAM mode antenna elements 410 when supporting the first OAM mode and the second OAM mode multiplexing scheme described herein.

As discussed herein, multiple modes may be multiplexed using a single power amplifier. In some examples, a receiver circle may include a smaller number of antenna elements than a transmitter circle. For example, a transmitter circle may include 16 antenna elements, and a receiver circle may include 8 antenna elements. Additionally or alternatively, multiple modes may be directed to the same user or receiving device. Further, the receiving device may include multiple circles of antenna elements, each with a smaller number of antennas (e.g., than the transmitter circle(s)), and one or more of the multiple circles may be used for reception. Further, the techniques described herein may be used for multi-user MIMO. In such cases, different modes may have different strengths at a certain distance. Accordingly, multiple users or devices may be positioned at different distances from the transmitter and may receive signals according to the different modes at the different distances. Even if a receiver circle and a transmitter circle includes the same number of antenna elements, the multiple modes used may provide degrees-of-freedom gain at the cost of lower array gain, resulting in throughput gain at high SNR.

FIG. 4B illustrates an OAM antenna array configuration 402 that may represent a circular antenna array 420-a (e.g., a transmitter circle) and a circular antenna array 420-b (e.g., a receiver circle), wherein a distance z separates the circular antenna arrays 420-a and 420-b. In some examples, OAM weighting vectors may be defined as vectors of OAM weights which may be applied to antenna elements of transmitter and/or receiver circles in order to generate and decode signals that correspond to OAM modes, respectively. For example, an OAM weighting vector 425-a may be associated with the circular antenna array 420-a (e.g., the transmitter circle), and an OAM weighting vector 425-b may be associated with the circular antenna array 420-b (the receiver circle). Based on the OAM weighting vector 425-a, the transmitter circle may have a radius r₁. Based on the OAM weighting vector 425-b, the receiver circle may have a radius r₂. Each OAM mode used in a transmitter and/or receiver circle may correspond to an OAM weighting vector, such as the OAM weighting vectors 420.

As described with reference to FIG. 3, the channel matrix may be denoted from each transmitter antenna subarray 315 to each receiver antenna subarray 345 as H, and then for the beamformed channel matrix \tilde{H}=H·[w₁, w₂, . . . , w_{L}]. Any two OAM weighting vectors of [w₁, w₂, . . . , w_{L}] (e.g., the OAM weighting vectors 420) may be orthogonal relative to each other. In some aspects, for N transmitter antenna subarrays 315 and N receiver antenna subarrays 345, the transfer matrix H may be found via discreet angular sampling using Equation 1, shown below.

$${H}_{m , n} ∝ \frac{exp ( j k \sqrt{{z}^{2} + {( {r}_{1} − {r}_{2} cos {θ}_{2} )}^{2} +} )}{\sqrt{{z}^{2} + {( {r}_{1} cos {θ}_{1} − {r}_{2} cos {θ}_{2} )}^{2} + {( {r}_{1} sin {θ}_{1} − {r}_{2} sin {θ}_{2} )}^{2}}} = \frac{exp \{ j k \sqrt{{z}^{2} + {r}_{1}^{2} + {r}_{2}^{2} − 2 {r}_{1} {r}_{2} cos ( {θ}_{1} − {θ}_{2} )} \}}{\sqrt{{z}^{2} + {r}_{1}^{2} + {r}_{2}^{2} − 2 {r}_{1} {r}_{2} cos ( {θ}_{1} − {θ}_{2} )}} \qquad ( 1 )$$

In the example of Equation 1, beamformed ports may not experience crosstalk if beamform vectors are the singular vectors of the transfer matrix H. This may enable OAM-based communication to realize high-level spatial multiplexing more efficiently. Further, the eigen-based transmit precoding weights and receive combining weights of UCA-based OAM procedures may be equal to a DFT matrix. As the transfer matrix H is cyclic or circulant, eigenvectors of the transfer matrix H may be DFT vectors, as described in Equation 2.

$${v}_{u} = exp \{ j \frac{2 πμ v}{N} \} \qquad ( 2 )$$

In the example of Equation 2, μ and v may be integers within a range (e.g., μ=0, 1, . . . (N−1), v=0,1, . . . (N−1)), where μ is a vector index of a DFT vector and v is the element index in each DFT vector. With respect to each OAM mode, the μ-th DFT vector may correspond to the μ-th OAM waveform. In some cases, the eigen modes may be identified by performing a singular value decomposition (SVD) on a transfer matrix. If a transmitter circle contains N antenna elements and a receiver circle contains N antenna elements, OAM modes 0, 1, . . . , N−1 may be orthogonal at the receiver circle if the OAM modes are transmitted, regardless of the distance z between the transmitter and receiver circles, the radius r₁ of the transmitter circle, or the radius r₂ of the receiver circle.

If a device uses multiple OAM modes in a circle of antenna elements as described herein, then the offset between the nodes (e.g., subsets of antenna elements) used for the multiple modes may not affect the circulant nature of the channel matrix and therefore multiple modes may be orthogonal. As described in reference with FIG. 4B and Equation 2, in a transmitter and/or receiver circle, a μ-th DFT vector may correspond to even antenna elements (e.g., v=0, 2, . . . (N−2)) (assuming N is even), and a μ′-th DFT vector may correspond to odd antenna elements (e.g., v=1, 3, . . . (N−1)). Thus, the μ′-th DFT vector may be projected to the even antenna elements with a fixed offset phase φ₀. If μ′+μ, receive beamforming by the even antenna elements may be represented by Equation 3. Accordingly, the multiple OAM modes involved in the circle may be orthogonal.

$${\sum }_{v = 0}^{\frac{N}{2} − 1} exp ( − j \frac{2 πμ ( 2 v )}{N} ) exp [ j \frac{2 {πμ}^{′} ( 2 v )}{N} + {φ}_{0} ] = {\sum }_{v = 0}^{\frac{N}{2} − 1} exp [ j \frac{2 π ( {μ}^{′} − μ ) ( 2 v )}{N} + {φ}_{0} ] = exp ( j {φ}_{0} ) {\sum }_{v = 0}^{\frac{N}{2} − 1} exp [ j \frac{2 π ( {μ}^{′} − μ ) v}{\frac{N}{2}} ] = 0 \qquad ( 3 )$$

In some examples, multiple OAM modes which are equal in size, different in order, and transmitted by evenly distributed antenna elements in a single circle (e.g., the first OAM mode antenna elements 405 and the second OAM mode antenna elements 410 in the OAM antenna array configuration 401) may be orthogonal on any one receiver antenna circle of equivalent size. For example, a single antenna circle may have N antenna elements, where N may be divisible by K. Each of the N antenna elements may be associated with an antenna index designated as 0, 1, . . . (N−1) on the modulo N basis. A first subset of the antenna elements, v, v+K, . . . , v+(N−K)), may transmit an OAM mode

$$( \frac{N}{K} , μ ) .$$

Additionally or alternatively, a second subset of the antenna elements, v′, v′+K, . . . , v′+(N−K)), may transmit an OAM mode

$$( \frac{N}{K} , {μ}^{′} )$$

The OAM vector associated with the OAM mode

$$( \frac{N}{K} , μ )$$

may be represented by Equation 4, and the OAM vector associated with the OAM mode

$$( \frac{N}{K} , {μ}^{′} )$$

may be represented by Equation 5.

$$exp [ − j ( \frac{2 πμ ( v + p )}{N / K} + φ ) ] , p = 0 , 1 , … N / K − 1 \qquad ( 4 )$$

$$exp [ − j ( \frac{2 {πμ}^{′} ( {v}^{′} + {p}^{′} )}{N / K} + {φ}^{′} ) ] , {p}^{′} = 0 , 1 , … N / K − 1 \qquad ( 5 )$$

In some examples, a receiver antenna circle containing N antenna elements may include a subset of N/K elements which are evenly distributed at angles of

$$\frac{2 π q}{N / K} + δ ,$$

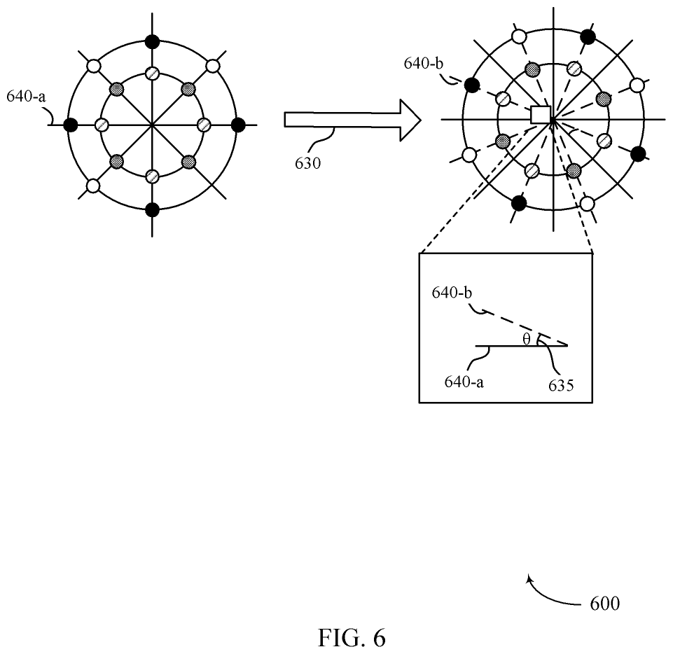

q=0, 1, N/K−1, where δ is an offset between the transmitter and receiver circles (e.g., an offset 635 of FIG. 6). Accordingly, the channel between a first subset of antenna elements at the transmitter circle and the first subset of antenna elements at the receiver circle may be circular. Additionally or alternatively, the channel between the second subset of antenna elements at the transmitter circle and the second subset of antenna elements at the receiver circle may be circular.

If the channel between the first subset of antenna elements at the transmitter circle and the first subset of antenna elements at the receiver circle is circular, then the OAM mode (N/K, μ) may be a singular vector. The channel associated with the first subsets may be received as represented in Equation 6. Additionally or alternatively, if the channel between the second subset of antenna elements at the transmitter circle and the second subset of antenna elements at the receiver circle is circular, then the OAM mode (N/K, μ) may be a singular vector. The channel associated with the second subsets may be received as represented in Equation 7.

$$exp [ − j ( \frac{2 πμ ( δ + q )}{N / K} + {φ}_{r} ) ] , q = 0 , 1 , … N / K − 1 \qquad ( 6 )$$

$$exp [ − j ( \frac{2 {πμ}^{′} ( δ + q )}{N / K} + {φ}_{r}^{′} ) ] , q = 0 , 1 , … N / K − 1 \qquad ( 7 )$$

If μ′≠μ, receive beamforming by the antenna elements associated with either subset may be represented by Equation 8. As shown in Equation 8, any angular offset between the transmitter antenna subsets and the receiver antenna subsets may not impact orthogonality. Accordingly, the OAM modes may provide robust performance in OAM communications.

$${\sum }_{q = 0}^{N / K − 1} exp [ − j ( \frac{2 πμ ( δ + q )}{N / K} + {φ}_{r} ) ] exp [ + j ( \frac{2 {πμ}^{′} ( δ + q )}{N / K} + {φ}_{r}^{′} ) ] = {\sum }_{q = 0}^{N / K − 1} exp [ j ( \frac{2 π q ( {μ}^{′} − μ ) K}{\frac{N}{K}} + \frac{+ 2 π ( {μ}^{′} − μ ) δ}{\frac{N}{K}} + {φ}_{r}^{′} − {φ}_{r} ) ] ∝ {\sum }_{q = 0}^{N / K − 1} exp [ j \frac{2 π q ( {μ}^{′} − μ )}{N / K} ] = 0 \qquad ( 8 )$$

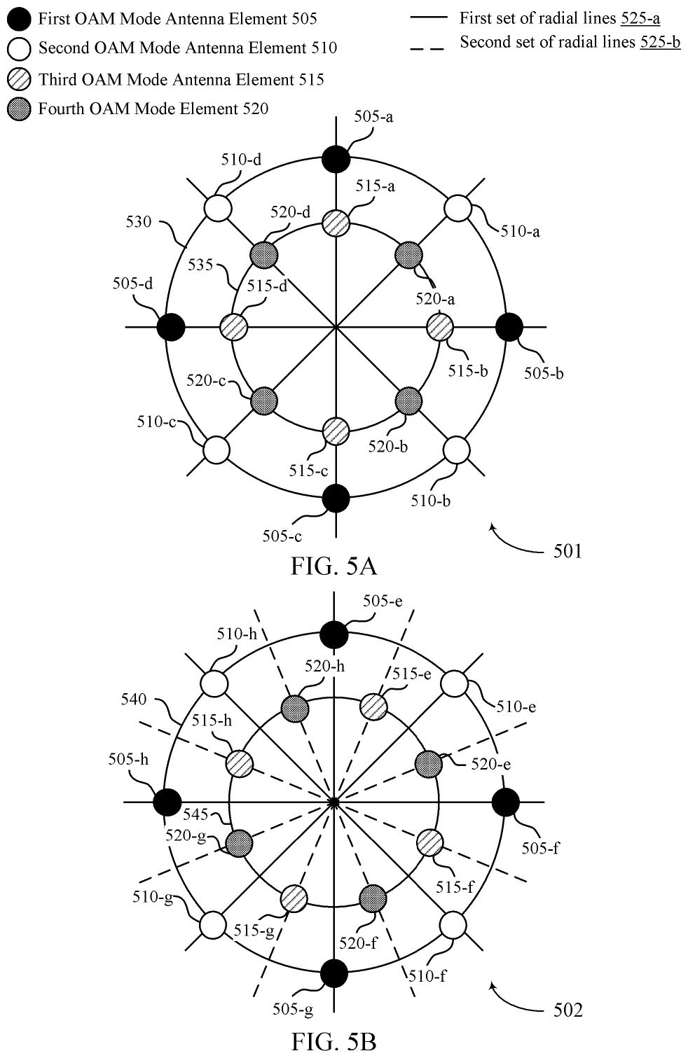

FIG. 5A and FIG. 5B illustrate examples of OAM antenna array configurations 501 and 502 that support OAM multiplexing using multiple modes in an antenna array in accordance with one or more aspects of the present disclosure. The OAM antenna array configurations 501 and 502 may implement or be implemented by aspects of the wireless communications system 100 or 200 or the OAM antenna array configuration 300. For example, the OAM antenna array configuration 501 illustrates a configuration of antenna elements at a transmitting device, a receiving device, or both. The transmitting and receiving devices may represent aspects of corresponding devices as described with reference to FIGS. 1-3 (e.g., a UE, a base station, a CU, a DU, an RU, an IAB node, or any other device).

FIG. 5A illustrates an OAM antenna array configuration 501 that may be an example of a first circular antenna array containing a first quantity of antenna elements in a first circle 530 that supports OAM multiplexing using multiple modes and a second quantity of antenna elements in a second circle 535 that also supports OAM multiplexing using multiple modes. The second circle 535 may be concentric with the first circle 530.

In this example, the transmitting and/or receiving device may include the first quantity of antenna elements disposed in the first circle 530, wherein the first quantity of antenna elements includes first OAM mode antenna elements 505 and second OAM mode antenna elements 510. In the same example, the transmitting and/or receiving device may also include the second quantity of antenna elements disposed in the circle 535, wherein the second quantity of antenna elements includes third OAM mode antenna elements 505 and fourth OAM mode antenna elements 510. In the example of FIG. 5A, the transmitting device, the receiving device, or both may include four antenna elements of each respective OAM mode. However, it is to be understood that the transmitting and receiving devices may include any quantity of antenna elements.

In the OAM antenna array configuration 501, the first quantity of antenna elements of the first circle 530 may be positioned at a first set of radial lines 525-a, and the second quantity of antenna elements may be positioned at a second set of radial lines, wherein the second set of radial lines is parallel with the first set of radial lines 525-a. As such, the antenna elements of the first circle 530 and the antenna elements of the second circle 535 may be positioned along the same radial lines in OAM antenna array configuration 501. It should be understood that the first set of radial lines 525-a (and the second set of radial lines 525-b of FIG. 5B) are included for illustrative purposes to show positioning of the sets of antenna elements. Thus, as illustrated in the OAM antenna array configuration 501, a first OAM mode antenna element 505-a of the first circle 530 is positioned in line with a third OAM mode antenna element 515-a on a respective radial line of the first set of radial lines 525-a.

In some examples, a device implementing the first circular antenna array may split the first quantity of antenna elements disposed into multiple OAM mode-specific subsets of antenna elements. In other words, a device implementing the OAM antenna array configuration 501 may segment the first quantity of antenna elements such that there is an alternating pattern (e.g., a staggering pattern) of antenna elements associated with a first OAM mode and a second OAM mode. For example, the first OAM mode antenna elements 505-a, 505-b, 505-c, and 505-d may be included in a first subset of the first quantity of antenna elements. Additionally or alternatively, the second OAM mode antenna elements 510-a, 510-b, 510-c, and 510-d may be included in a second subset of the first quantity of antenna elements. Accordingly, the first OAM mode antenna elements 505 and the second OAM mode antenna elements 510 may be disposed in the circle 530 in a first alternating pattern.

In a second circle 535, which may be concentric with the first circle 530 containing the first quantity of antenna elements, the OAM antenna array configuration 501 may segment the second quantity of antenna elements such that there is a second alternating pattern of antenna elements associated with a third OAM mode and a fourth OAM mode. For example, the third OAM mode antenna elements 515-a, 515-b, 515-c, and 515-d may be included in a first subset of the second quantity of antenna elements. Additionally or alternatively, the fourth OAM mode antenna elements 520-a, 520-b, 520-c, and 520-d may be included in a second subset of the second quantity of antenna elements. Accordingly, the third OAM mode antenna elements 515 and the fourth OAM mode antenna elements 520 may be disposed in the second circle 535 in the second alternating pattern. In some aspects, the transmitting device, the receiving device, or both may be configured to have an alternating, or staggered, pattern of antenna elements associated with multiple modes in one or more concentric circles in addition to the first circle 530 and the second circle 535 depicted in FIG. 5A and FIG. 5B.

FIG. 5B illustrates an OAM antenna array configuration 502 that may be an example of a first circular antenna array containing a first quantity of antenna elements in a first circle 540 that supports OAM multiplexing using multiple modes and a second quantity of antenna elements in a second circle 545 that also supports OAM multiplexing using multiple modes. The transmitting device may include a first circular antenna array that contains a first quantity of antenna elements disposed in a first circle 540 and a second quantity of antenna elements disposed in a second circle 545. As illustrated in FIG. 5B, the second circle 545 containing the second quantity of antenna elements may be concentric with the first circle 540 containing the first quantity of antenna elements. Similarly, the receiving device may include a first circular antenna array that contains the first quantity of antenna elements disposed in the first circle 540 and the second quantity of antenna elements disposed in the second circle 545.

As illustrated in FIG. 5B, the first quantity of antenna elements disposed in the first circle 540 may include first OAM mode antenna elements 505 and second OAM mode antenna elements 510. Additionally or alternatively, the second quantity of antenna elements disposed in the second circle 545 may include third OAM mode antenna elements 515 and fourth OAM mode antenna elements 520. In the example of FIG. 5B, the transmitting device, the receiving device, or both may include four antenna elements of each respective OAM mode. However, it is to be understood that the transmitting and receiving devices may include any quantity of antenna elements. In the OAM antenna array configuration 502, the first quantity of antenna elements may be positioned at a first set of radial lines 525-a, and the second quantity of antenna elements may be positioned at a second set of radial lines 525-b that is offset with the first set of radial lines 525-a. Thus, a radial line of the second set of radial lines 525-b may bisect two radial lines of the first set of radial lines 525-a. The offsets (as illustrated in FIG. 5B) between the concentric circles (e.g., the first circle 540 and the second circle 545) may be implemented to increase antenna separation. As described above, the radial lines (the first set of radial lines 525-a and the second set of radial lines 525-b) are included for illustrative purposes to show positioning of antenna elements.

A device may split the first quantity of antenna elements disposed in the circle into multiple OAM mode-specific subsets of antenna elements. In other words, a device implementing the OAM antenna array configuration 502 may segment the first quantity of antenna elements of the first circle 540 such that there is an alternating pattern of antenna elements associated with a first OAM mode and a second OAM mode. First OAM mode antenna elements 505-e, 505-f, 505-g, and 505-h may be included in a first subset of the first quantity of antenna elements. Additionally or alternatively, second OAM mode antenna elements 510-e, 510-f, 510-g, and 510-h may be included in a second subset of the first quantity of antenna elements. In the second circle 545, the OAM antenna array configuration 502 may segment the second quantity of antenna elements such that there is a second alternating pattern of antenna elements associated with a third OAM mode and a fourth OAM mode. For example, third OAM mode antenna elements 515-e, 515-f, 515-g, and 515-h may be included in a first subset of the second quantity of antenna elements. Additionally or alternatively, fourth OAM mode antenna elements 520-e, 520-f, 520-g, and 520-h may be included in a second subset of the second quantity of antenna elements.

As described in more detail herein, the multiple OAM modes of circle may be orthogonal among themselves, and may be orthogonal to other OAM modes on other circles. Further, as described with respect to FIG. 6, the offset between circles and the offset between transmission and reception panels may be chosen in the same way as would be performed with one OAM mode in each circle. Additionally, if radial modes are desired to further increase the degrees of freedom, these modes may be applied through beamforming across the azimuth modes across circles. The same azimuth mode may be applied to antenna nodes on multiple circles. In some examples, the multiple OAM modes may have different propagation loss between a transmitter and receiver circle pair. For this reason, the receiving device may receive multiple modes via multiple circles. Additionally or alternatively, on a circle, a device may have more receiver antenna elements than transmitter antenna elements for an OAM mode.

FIG. 6 illustrates an example of an OAM antenna array system 600 that supports OAM multiplexing using multiple modes in an antenna array in accordance with one or more aspects of the present disclosure. The OAM antenna array system includes OAM array configurations 601 and 602 may implement or be implemented by aspects of the wireless communications systems 100 and 200 or the OAM antenna array configuration 300. For example, the OAM antenna array configuration 601 illustrates a configuration of antenna elements at a transmitting device, and the OAM antenna array configuration 602 illustrates a configuration of antenna elements at a receiving device that is radially offset from the OAM antenna array configuration 601. The transmitting and receiving devices may represent aspects of corresponding devices as described with reference to FIGS. 1-3 (e.g., a UE, a base station, a CU, a DU, an RU, an IAB node, or any other device).

FIG. 6 illustrates an OAM antenna array configuration 601 at a transmitting device (e.g., transmitting one or more signals 630 to receiving device) that may be an example of a first circular antenna array containing a first quantity of antenna elements in a first circle that supports OAM multiplexing using multiple modes and a second quantity of antenna elements in a second circle that also supports OAM multiplexing using multiple modes. In the first circle, the first quantity of antenna elements may include first OAM mode antenna elements 605 and second OAM mode antenna elements 610. In the second circle, the second quantity of antenna elements may include third OAM mode antenna elements 615 and a subset of fourth OAM mode antenna elements 620. In the OAM antenna array configuration 602, the transmitting device may include four antenna elements of each respective OAM mode. However, it is to be understood that the transmitting device may include any quantity of antenna elements.

In the OAM antenna array configuration 601, the first quantity of antenna elements of the first circle and the second quantity of antenna elements of the second circle may be positioned at a first set of radial lines 625-a (e.g., respective sets of parallel lines). A device implementing the first circular antenna array may split the first quantity of antenna elements and/or the second quantity of antenna elements disposed in the respective circles into multiple OAM mode-specific subsets of the quantity of antenna elements as described with respect to FIGS. 5A and 5B.

Additionally, FIG. 6 illustrates an OAM antenna array configuration 602 at a receiving device (receiving the one or more signals 630 from the transmitting device) that may be an example of a first circular antenna array containing a first quantity of antenna elements in a first circle that supports OAM multiplexing using multiple modes and a second quantity of antenna elements in a second circle that also supports OAM multiplexing using multiple modes. In the first circle, the first quantity of antenna elements may include first OAM mode antenna elements 605 and second OAM mode antenna elements 610. In the second circle, the second quantity of antenna elements may include third OAM mode antenna elements 615 and fourth OAM mode antenna elements 620. In the OAM antenna array configuration 602, the receiving device may include four antenna elements of each respective OAM mode. However, it is to be understood that the receiving device may include any quantity of antenna elements.

In some aspects, the antenna elements on each device may be installed or dynamically adjusted or activated such that they are aligned along a first axis (e.g., a horizontal or vertical axis) as well as rotationally (e.g., the transmitter antenna elements may be aligned with the receiver antenna elements in various rotational axes). Additionally or alternatively, any angular offset (e.g., an offset 635) may be applied between the transmitter antenna elements and the receiver antenna elements. For example, OAM communications may support relatively high-order spatial multiplexing, and in some aspects, angular offsets between antenna elements may be configured to improve orthogonality between signals and improve data throughput.

In the OAM antenna array configuration 601, the first and second quantities of antenna elements may be positioned at a first set of radial lines 625-a (e.g., respective sets of parallel lines). In the OAM antenna array configuration 602, the first and second quantities of antenna elements at the receiving device may be radially offset from the first and second quantities of antenna elements represented in the OAM antenna array configuration 601 at the transmitting device (e.g., by the offset 635). In some examples, a second set of radial lines 625-b may be separated from the first set of radial lines 625-a by the offset 635. Accordingly, the first and second quantities of antenna elements in the OAM antenna configuration 602 at the receiving device may be positioned at the second set of radial lines 625-b.

The first circular antenna array may split the first quantity of antenna elements disposed in the first circle into multiple OAM mode-specific subsets of the quantity of antenna elements. In other words, the OAM antenna array configuration 602 may segment the first quantity of antenna elements such that there is an alternating pattern of first OAM mode antenna elements 605 and second OAM mode antenna elements 610. In a second circle which may be concentric with the first circle containing the first quantity of antenna elements, the OAM antenna array configuration 602 may segment the second quantity of antenna elements such that there is a second alternating pattern of third OAM mode antenna elements 615 and fourth OAM mode antenna elements 620.

In some cases (not illustrated in FIG. 6), the transmitter circle at the transmitting device and the receiver circle at the receiver device may be angularly aligned (e.g., offset 635 is 0). For example, there may not be an offset between a first circular antenna array of the transmitter circle and a first circular antenna array of the receiver circle. In such cases, aliasing may occur, which may reduce data throughput and a reliability of communications. Aliasing may correspond to an underrepresentation of a system when the system is represented by finite samples. For example, sampling a continuous signal may create interference or may permit at least some misrepresentation of the continuous signal, which may be referred to as aliasing.

As described herein, the antenna subarrays of the transmitter circle depicted in FIG. 6A may be offset from the antenna subarrays in the receiver circle by a nonzero angular offset 635 to reduce effects of aliasing. The offset 635 may be a negative or positive rotational angle between a first transmitter antenna subarray of the transmitter circle illustrated in FIG. 6A and a first receiver antenna subarray of the receiver circle illustrated in FIG. 6B. The respective first antenna subarrays may be defined arbitrarily or based on a location of an axis or other reference in the panel, such as an x-axis or y-axis through the circular plane, with an origin at the center of the transmitter and receiver circles. In some examples, transmitter and receiver devices with multiple modes on multiple circles may be configured with an angular offset between the multiple circles (e.g., as illustrated in FIG. 5B) and with an angular offset between transmitter and receiver panels.

A reference line at the transmitting device may be defined as the line 640-a from the center of the panel to a first OAM mode transmitter antenna element. A reference line at the receiving device may be defined as the line 640-b from the center of the panel to a first OAM mode receiver antenna element. As described with respect FIG. 4B, since the offset between nodes for multiple modes in a single circle may not impact the orthogonality between modes, the transmission device and reception device offset may be selected in a similar way. The offset 635 may be define as the rotational angle, θ, between the reference lines 640-a and 640-b for the transmitting and receiving devices, respectively. The offset 635 may be configured as a positive or negative nonzero value to reduce effects of aliasing as described herein. When there are the same quantity of transmitter antenna subarrays as receiver antenna subarrays (e.g., M=N), the first non-zero aliasing term may be

$${θ}_{0} = \pm \frac{π}{2 N} .$$

When there are a different quantity of transmitter antenna subarrays than receiver antenna subarrays (e.g., M≠N), the first non-zero aliasing term may be indexed by

$${v}_{min} = \frac{M}{gcd ( M , N )} ,$$

and the choice for the Tx-RX offset may be

$${θ}_{0} = \pm \frac{π}{2 {Nv}_{min}} .$$

This result may be true if M is the actual number of antenna used for transmission.

Further, as described herein, in a scenario depicted in FIG. 6, the capability of splitting or partitioning a circle by a transmitter (e.g., a device implementing OAM antenna array configuration 601) may signal the capability of partitioning the circle to a receiver (e.g., a device implementing OAM antenna array configuration 602) through system broadcast tor dedicated RRC signaling. In such cases, the receiver may consider, for a particular pair of reception and transmission circles, whether the receiver is configured to support a single mode from the transmission circle and its channel gain or whether the receiver is configured to support multi-modes in one or more transmission circles, a staggering pattern (offset p) and/or the corresponding channel gain for multi-modes. Further, the transmitter may transmit a set of reference signals (e.g., signals 630) using one or more modes as described herein. The receiver may respond to the reference signals with channel state feedback in conjunction with a choice of either a single and/or multiple modes per transmission circle. In some cases, the receiver may feedback information associated with mode the single OAM mode transmission mode and the multi-OAM mode transmission mode.

In some cases, devices implementing multi-OAM mode per circular antenna array may signal a topology of one or more antenna circles including dimensions, the number of circles, the number of elements on each circle, PA chain information, receive chain information, the number of beamformers, or a combination thereof to facilitate the choice of multiplexing. The transmitter (e.g., or a scheduling device) may determine possible sets of modes which may be multiplexed on each transmission circle. In some examples, the scheduling device may configure the reference signals to support channel quality measurement to determine a specific multiplexing scheme.

To support channel quality measurements, a channel matrix may be determined based on the number of circles (M) and the number of elements per circle (N). A full channel matrix may be of size (MN)*(MN) but each pair of circles m₁, m₂, the N*N submatrix is circulant. A full channel matrix may be represented as follows:

$$H = [ \begin{matrix}{H}_{11} & {H}_{12} & & {H}_{1 M} \\ {H}_{21} & {H}_{22} & … & {H}_{2 M} \\ … & … & … & … \\ {H}_{M 1} & {H}_{M 2} & … & {H}_{M M}\end{matrix} ]$$

with Hₘ_{₁}ₘ_{₂}, a N*N circulant matrix whose element (Hₘ_{₁}ₘ_{₂})ₙ_{₁}ₙ_{₂} the complex channel gain between the tx-rx antenna pair n₁n₂. Based on the result about DFT vectors being the eigenvectors of a circulant matrix, it follows that: Hₘ_{₁}ₘ_{₂}eₚ=hₘ_{₁}ₘ_{_{2, p}} eₚ, where p-th DFT vector

$${e}_{p} = \{ exp ( \frac{j 2 π pq}{N} ) \} ,$$

q=0, 1, . . . (N−1); hₘ_{₁}ₘ_{_{2, p}} is the p-th complex eigenvalue, which is the p-th value in the DFT of a row vector in Hₘ_{₁}ₘ_{₂} From the above result:

$${h}_{{m}_{1} {m}_{2} , p} ∝ {J}_{p} ( \frac{2 π {r}_{1} {r}_{2}}{λ z} ) .$$

Thus, the eigenvectors of H has the form of {x₁eₚ,x₂eₚ, . . . xₘeₚ}^{T}, p=0, 1, . . . (N−1).

The circular antenna arrays may support azimuth modes from 0 to (N−1) with phase difference of

$$\frac{2 π q}{N} ,$$

p=0, 1, . . . (N−1). The beamforming vectors may be the eigenvectors of p-th DFT vector

$${e}_{p} = \{ exp ( \frac{j 2 π pq}{N} ) \} ,$$

q=0, 1, . . . (N−1); The (partial) Beam strength may be the eigenvalue: p-th DFT of row vector in Hₘ_{₁}ₘ_{₂}. The radial modes from 0 to (M−1) for each of the azimuth mode. Beamforming vectors/eigenvectors and (complete) beam strength/eigenvalues may be those from the intermediate matrix:

$$[ \begin{matrix}{h}_{11 , p} & {h}_{12 , p} & & {h}_{1 M , p} \\ {h}_{21 , p} & {h}_{22 , p} & … & {h}_{2 M , p} \\ … & … & … & … \\ {h}_{M 1 , p} & {h}_{M 2 , p} & … & {h}_{MM , p}\end{matrix} ] ,$$

where hₘ_{₁}ₘ_{_{2, p}} is the p-th eigenvalue of the block matrix Hₘ_{₁}ₘ_{₂}eₚ=hₘ_{₁}ₘ_{_{2, p}} eₚ.

The beamforming along the radial direction may depend on the azimuth mode. A radial beamforming vector may be applied to circles with the same azimuth mode. If multiple azimuth modes are multiplexed in a circle, antennas of each mode across circles may be beamformed along the radial direction. Thus, the assumption of a single PA may be broken. The beamforming vectors along the radial direction may be obtained by the SVD process (with simplified channel matrix of reduced dimension) or by a codewords based approach.

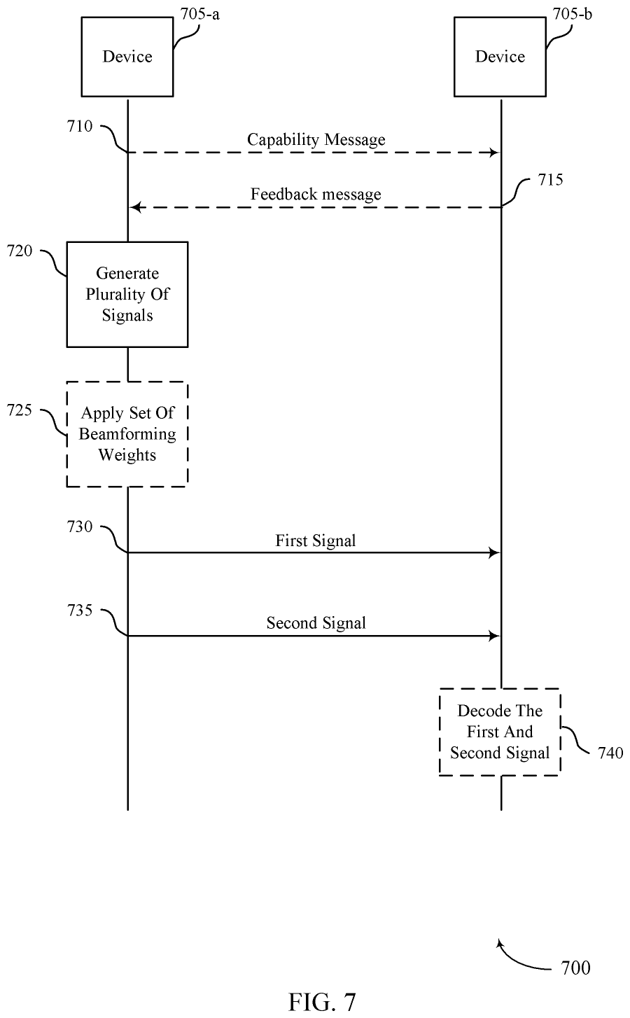

FIG. 7 illustrates an example of a process flow 700 that supports OAM multiplexing using multiple modes in an antenna array in accordance with one or more aspects of the present disclosure. The process flow 700 may implement or be implemented by aspects of the wireless communications systems 100 and 200 or the OAM antenna array configurations 300, 401, 402, 501, 502, 601, or 602. For example, the process flow 700 illustrates OAM communications between a device 705-a and a device 705-b, which may represent aspects of corresponding devices or network nodes as described with reference to FIGS. 1-6. The devices 705 may be UEs, base stations, IAB nodes, RUs, CUs, DUs, any other network node, or any combination thereof, that support OAM communications.

The device 705-a may include transmitting antenna array with a first quantity of antenna elements disposed in a circle, and the device 705-b may include a receiving circular antenna array with a first quantity of antenna elements disposed in a circle.

In the following description of the process flow 700, the operations between the device 705-a and the device 705-b may be performed in different orders or at different times. Some operations may also be left out of the process flow 700, or other operations may be added. Although the device 705-a and the device 705-b are shown performing the operations of the process flow 700, some aspects of some operations may also be performed by one or more other wireless devices.

At 710, the device 705-a may transmit, and the device 705-b may receive, a capability message. By transmitting the capability message, the device 705-a may specify that the device 705-a may be capable of transmitting signals using a multimode transmission mode for a circular antenna array, where a first OAM mode may use a first subset of antenna elements disposed in the circle and a second OAM mode may use a second subset of antenna elements disposed in the same circle. In some aspects, the device 705-a may transmit the capability message by using a RRC signal or a system broadcast signal. In some cases, the device 705-a may transmit an indication of a topology of the first circular antenna array. In some examples, the topology may contain information about properties of first circular antenna array, such as a number of circles, a quantity of antenna elements in one or more of the circles, a quantity of power amplifiers for the one or more circles, a quantity of digital beamformers for the one or more circles, or a combination thereof. The indication of topology may be transmitted as part of the capability message transmitted at 710 or may be a separate control message.

At 715, the device 705-b may transmit, and the device 705-a may receive, a feedback message. By transmitting the feedback message, the device 705-b may indicate that the first device 705-a may use the multimode transmission mode from among the options of a single mode transmission mode and the multimode transmission mode. Additionally or alternatively, the feedback message may contain information associated with both the single mode transmission mode and the multimode transmission mode. In some examples, the feedback message indicates one or more channel quality indications corresponding to each antenna element of the first quantity of antenna elements, each mode of the first orbital angular momentum mode and the second orbital angular momentum mode, or a combination thereof.

At 720, the device 705-a may generate a plurality of signals. For example, the device 705-a may generate a first plurality of signals for transmission from the device 705-a via the first circular antenna array, which may contain the first quantity of antenna elements arranged in the circle. In some aspects, the generated signals may include reference signals such as CSI-RSs or SRSs, control messages, data, or a combination thereof.

At 725, in some aspects, the device 705-a may apply a set of beamforming weights for transmission of the first signal and the second signal of the first plurality of signals. In some examples, the device 705-a may determine or identify multiple sets of beamforming weights based on a previously received feedback message. For example, the device 705-a may identify the multiple sets of beamforming weights based on the indication of the beamforming weights via a previously received feedback message or based on channel quality measurements indicated via the previously received feedback message. In some examples, the device 705-a may use a first quantity of phasors to apply a set of beamforming weights to respective antenna elements which may be used to transmit the first signal and the second signal of the first plurality of signals. In such examples, each phasor of the first quantity of phasors may correspond to a respective antenna element of the first quantity of antenna elements. Additionally or alternatively, the device 705-b may use a second quantity of phasors to apply a set of beamforming weights to respective antenna elements which may be used to receive signals from the first device 705-a.

At 730, the device 705-a may transmit a first signal of the first plurality of signals using a first OAM mode and the first subset of the first quantity of antenna elements disposed in the circle. The device 705-a may transmit the one or more signals using the transmitter circle, and the device 705-b may receive the one or more signals using the receiver circle.

At 735, the device 705-a may transmit a second signal of the first plurality of signals using a second OAM mode and a second subset of the first quantity of antenna elements disposed in a circle. Similar to at 730, the device 705-a may transmit the one or more signals using the transmitter circle, and the device 705-b may receive the one or more signals using the receiver circle. Each signal of the one or more signals may be associated with a respective set of beamforming weights of the multiple sets of beamforming weights.

At 740, the device 705-b may decode the first signal of the first plurality of signals by using the first OAM mode and the first subset of the first quantity of antenna elements at the device 705-b, and may also decode the second signal of the first plurality of signals by using the second OAM mode and the second subset of the first quantity of antenna elements at the device 705-b.

The first device 705-a and the second device 705-b may thereby support OAM beamforming and multiplexing using multiple OAM modes at transmitter and receiver circles to increase data throughput and provide improved resource utilization. In some examples, the first device 705-a may support at least a third and fourth OAM mode using a second quantity of antenna elements disposed in a second circle that is concentric with the first circle containing the first quantity of antenna elements. In such cases, the first device 705-a may transmit (and receive) signals using the third and fourth mode and respective subsets of the second quantity of antenna elements of the second circle. Similarly, the second device 705-a may support at least a third and fourth OAM mode using a second quantity of antenna element disposed in a second circle that is concentric with the first circle of the second device 705-b. The second device 705-a may receive (and transmit) signals using the third and fourth mode and respective subsets of antenna elements of the second quantity of antenna elements disposed in the second circle of the second device 705-b.

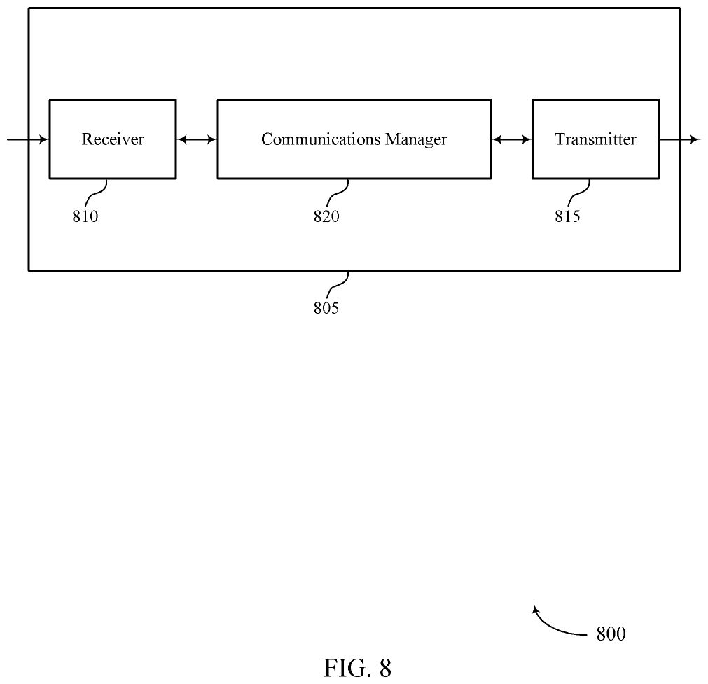

FIG. 8 shows a block diagram 800 of a device 805 that supports OAM multiplexing using multiple modes in an antenna array in accordance with one or more aspects of the present disclosure. The device 805 may be an example of aspects of a UE 115 or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to OAM multiplexing using multiple modes in an antenna array). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to OAM multiplexing using multiple modes in an antenna array). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of OAM multiplexing using multiple modes in an antenna array as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first device in accordance with examples as disclosed herein. For example, the communications manager 820 may be configured as or otherwise support a means for generating a set of multiple signals for transmission from the first device via a first circular antenna array that includes a first quantity of antenna elements disposed in a circle. The communications manager 820 may be configured as or otherwise support a means for transmitting a first signal of the set of multiple signals using a first OAM mode and a first subset of the first quantity of antenna elements disposed in the circle. The communications manager 820 may be configured as or otherwise support a means for transmitting a second signal of the set of multiple signals using a second OAM mode and a second subset of the first quantity of antenna elements disposed in the circle, where the second subset is exclusive of the first subset.

Additionally, or alternatively, the communications manager 820 may support wireless communication at a first device in accordance with examples as disclosed herein. For example, the communications manager 820 may be configured as or otherwise support a means for receiving, at a first circular antenna array including a first quantity of antenna elements disposed in a circle, a first signal of a set of multiple signals using a first OAM mode and a first subset of the first quantity of antenna elements disposed in the circle. The communications manager 820 may be configured as or otherwise support a means for receiving a second signal of the set of multiple signals using a second OAM mode and a second subset of the first quantity of antenna elements disposed in the circle, where the second subset is exclusive of the first subset. The communications manager 820 may be configured as or otherwise support a means for decoding the first signal received using the first OAM mode and the first subset and the second signal received using the second OAM mode and the second subset.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced power consumption, more efficient utilization of communication resources, and higher throughput. For example, the device 805 may include a first circular antenna array and may support communications with a second device by using multiple OAM modes via the first circular antenna array. By supporting communications between such devices and using multiple modes in a circle of antenna elements, the number of power amplifiers for operations may be reduced, which may provide for improved utilization of resources and reduced power consumption. Additionally, using multiple OAM modes in a single circle may provider higher degrees-of-freedom at a smaller array gain, which may improve throughput of communications. In some aspects, an angular offset may be configured between an antenna subarray of the device 805 and an antenna subarray of the other device, which may reduce aliasing and improve throughput.

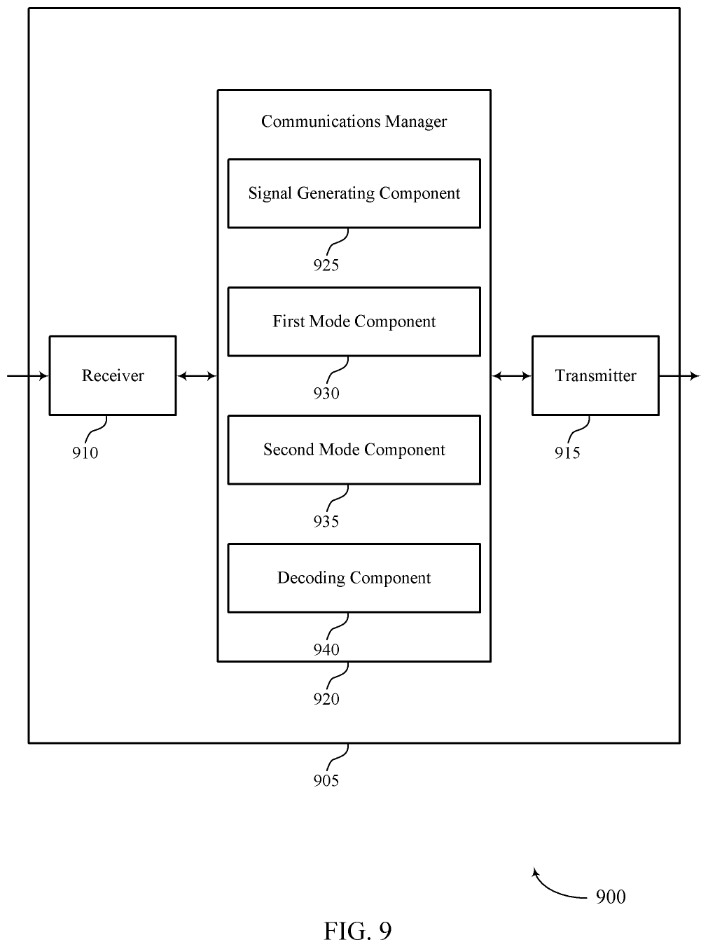

FIG. 9 shows a block diagram 900 of a device 905 that supports OAM multiplexing using multiple modes in an antenna array in accordance with one or more aspects of the present disclosure. The device 905 may be an example of aspects of a device 805, a UE 115, or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to OAM multiplexing using multiple modes in an antenna array). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to OAM multiplexing using multiple modes in an antenna array). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of OAM multiplexing using multiple modes in an antenna array as described herein. For example, the communications manager 920 may include a signal generating component 925, a first mode component 930, a second mode component 935, a decoding component 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a first device in accordance with examples as disclosed herein. The signal generating component 925 may be configured as or otherwise support a means for generating a set of multiple signals for transmission from the first device via a first circular antenna array that includes a first quantity of antenna elements disposed in a circle. The first mode component 930 may be configured as or otherwise support a means for transmitting a first signal of the set of multiple signals using a first OAM mode and a first subset of the first quantity of antenna elements disposed in the circle. The second mode component 935 may be configured as or otherwise support a means for transmitting a second signal of the set of multiple signals using a second OAM mode and a second subset of the first quantity of antenna elements disposed in the circle, where the second subset is exclusive of the first subset.

Additionally, or alternatively, the communications manager 920 may support wireless communication at a first device in accordance with examples as disclosed herein. The first mode component 930 may be configured as or otherwise support a means for receiving, at a first circular antenna array including a first quantity of antenna elements disposed in a circle, a first signal of a set of multiple signals using a first OAM mode and a first subset of the first quantity of antenna elements disposed in the circle. The second mode component 935 may be configured as or otherwise support a means for receiving a second signal of the set of multiple signals using a second OAM mode and a second subset of the first quantity of antenna elements disposed in the circle, where the second subset is exclusive of the first subset. The decoding component 940 may be configured as or otherwise support a means for decoding the first signal received using the first OAM mode and the first subset and the second signal received using the second OAM mode and the second subset.

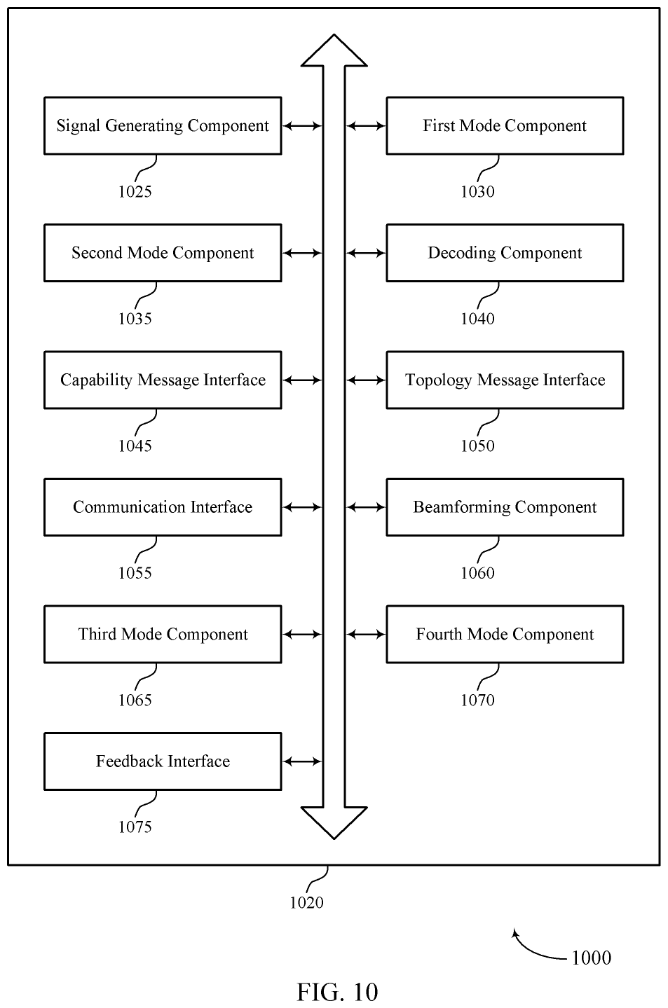

FIG. 10 shows a block diagram 1000 of a communications manager 1020 that supports OAM multiplexing using multiple modes in an antenna array in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of OAM multiplexing using multiple modes in an antenna array as described herein. For example, the communications manager 1020 may include a signal generating component 1025, a first mode component 1030, a second mode component 1035, a decoding component 1040, a capability message interface 1045, a topology message interface 1050, a communication interface 1055, a beamforming component 1060, a third mode component 1065, a fourth mode component 1070, a feedback interface 1075, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a first device in accordance with examples as disclosed herein. The signal generating component 1025 may be configured as or otherwise support a means for generating a set of multiple signals for transmission from the first device via a first circular antenna array that includes a first quantity of antenna elements disposed in a circle. The first mode component 1030 may be configured as or otherwise support a means for transmitting a first signal of the set of multiple signals using a first OAM mode and a first subset of the first quantity of antenna elements disposed in the circle. The second mode component 1035 may be configured as or otherwise support a means for transmitting a second signal of the set of multiple signals using a second OAM mode and a second subset of the first quantity of antenna elements disposed in the circle, where the second subset is exclusive of the first subset.

In some examples, the capability message interface 1045 may be configured as or otherwise support a means for transmitting an capability message specifying that that the first device is capable of transmitting signals using a multimode transmission mode including the first OAM mode using the first subset of antenna elements disposed in the circle and the second OAM mode using the second subset of antenna elements disposed in the circle.

In some examples, to support transmitting the capability message, the capability message interface 1045 may be configured as or otherwise support a means for transmitting the capability message using a radio resource control signal or a system broadcast signal.

In some examples, the feedback interface 1075 may be configured as or otherwise support a means for receiving, from a second device, a feedback message indicating that the first device is to use the multimode transmission mode from among a single mode transmission mode and the multimode transmission mode.

In some examples, the topology message interface 1050 may be configured as or otherwise support a means for transmitting an indication of a topology of the first circular antenna array, where the topology includes a number of circles of the first circular antenna array, a quantity of antenna elements in one or more circles of the first circular antenna array, a quantity of power amplifiers for the one or more circles, a quantity of digital beamformers for the one or more circles, or a combination thereof.

In some examples, the topology message interface 1050 may be configured as or otherwise support a means for receiving, from a second device, an indication of a topology of a second circular antenna array of the second device, where the topology includes a number of circles of the second circular antenna array, a quantity of antenna elements in one or more circles of the second circular antenna array, a quantity of power amplifiers for the one or more circles, a quantity of digital beamformers for the one or more circles, or a combination thereof.

In some examples, to support transmitting the first signal and transmitting the second signal, the communication interface 1055 may be configured as or otherwise support a means for transmitting the first signal using the first OAM mode and the second signal using the second OAM mode based on a topology of the first circular antenna array, a topology of a second circular antenna array of a second device, or a combination thereof.

In some examples, to support transmitting the first signal and transmitting the second signal, the first mode component 1030 may be configured as or otherwise support a means for transmitting the first signal including a first set of reference signals. In some examples, to support transmitting the first signal and transmitting the second signal, the second mode component 1035 may be configured as or otherwise support a means for transmitting the second signal including a second set of reference signals.

In some examples, the feedback interface 1075 may be configured as or otherwise support a means for receiving, from a second device based on transmitting the first set of reference signals and the second set of reference signals, a feedback message indicating one or more channel quality indications corresponding to each antenna element of the first quantity of antenna elements, each mode of the first OAM mode and the second OAM mode, or a combination thereof.

In some examples, the communication interface 1055 may be configured as or otherwise support a means for transmitting one or more subsequent signals using the first OAM mode, the second OAM mode, or both, based on the one or more channel quality indications.

In some examples, each antenna element of the first subset and each antenna element of the second subset are disposed in the circle in an alternating pattern.

In some examples, to support transmitting the first signal and transmitting the second signal, the first mode component 1030 may be configured as or otherwise support a means for transmitting the first signal using a first power applied by a first power amplifier corresponding to the first subset of antenna elements and the first OAM mode. In some examples, to support transmitting the first signal and transmitting the second signal, the second mode component 1035 may be configured as or otherwise support a means for transmitting the second signal using a second power applied by a second power amplifier corresponding to the second subset of antenna elements and the second OAM mode.

In some examples, the beamforming component 1060 may be configured as or otherwise support a means for applying a set of beamforming weights for transmission of the first signal and the second signal using a first quantity of phasors, where each phasor of the first quantity of phasors corresponds to a respective antenna element of the first quantity of antenna elements.

In some examples, the signal generating component 1025 may be configured as or otherwise support a means for generating a second set of multiple signals for transmission from the first device via the first circular antenna array that includes a second quantity of antenna elements disposed in a second circle. In some examples, the third mode component 1065 may be configured as or otherwise support a means for transmitting a first signal of the second set of multiple signals using a third OAM mode and a first subset of the second quantity of antenna elements disposed in the second circle. In some examples, the fourth mode component 1070 may be configured as or otherwise support a means for transmitting a second signal of the second set of multiple signals using a fourth OAM mode and a second subset of the second quantity of antenna elements disposed in the second circle, where the second subset of the second quantity of antenna elements is exclusive of the first subset of the second quantity of antenna elements and where the circle and the second circle are concentric.

In some examples, the first quantity of antenna elements are positioned at a first set of radial lines of the circle. In some examples, the second quantity of antenna elements are positioned a second set of radial lines in the second circle and the second set of radial lines are offset between the first set of radial lines.

In some examples, the first quantity of antenna elements are positioned at a first set of radial lines of the circle and the second quantity of antenna elements are positioned a second set of radial lines in the second circle. In some examples, the second set of radial lines are parallel with the first set of radial lines.

In some examples, to support transmitting the first signal and transmitting the second signal, the communication interface 1055 may be configured as or otherwise support a means for transmitting, to a second device, the first signal and the second signal using the first quantity of antenna elements that are radially offset from a second quantity of antenna elements of the second device.

Additionally, or alternatively, the communications manager 1020 may support wireless communication at a first device in accordance with examples as disclosed herein. In some examples, the first mode component 1030 may be configured as or otherwise support a means for receiving, at a first circular antenna array including a first quantity of antenna elements disposed in a circle, a first signal of a set of multiple signals using a first OAM mode and a first subset of the first quantity of antenna elements disposed in the circle. In some examples, the second mode component 1035 may be configured as or otherwise support a means for receiving a second signal of the set of multiple signals using a second OAM mode and a second subset of the first quantity of antenna elements disposed in the circle, where the second subset is exclusive of the first subset. The decoding component 1040 may be configured as or otherwise support a means for decoding the first signal received using the first OAM mode and the first subset and the second signal received using the second OAM mode and the second subset.

In some examples, the capability message interface 1045 may be configured as or otherwise support a means for receiving, from a second device, a capability message specifying that that the first device is capable of transmitting signals using a multimode transmission mode.

In some examples, to support receiving the capability message, the capability message interface 1045 may be configured as or otherwise support a means for receiving the capability message using a radio resource control signal or a system broadcast signal.

In some examples, the feedback interface 1075 may be configured as or otherwise support a means for transmitting, to the second device, a feedback message indicating that the first device is to use the multimode transmission mode from among a single mode transmission mode and the multimode transmission mode.

In some examples, the topology message interface 1050 may be configured as or otherwise support a means for receiving, from a second device, an indication of a topology of a second circular antenna array of the second device, where the topology includes a number of circles of the second circular antenna array, a quantity of antenna elements in one or more circles of the second circular antenna array, a quantity of power amplifiers for the one or more circles, a quantity of digital beamformers for the one or more circles, or a combination thereof.

In some examples, the topology message interface 1050 may be configured as or otherwise support a means for transmitting, to a second device, an indication of a topology of the first circular antenna array, where the topology includes a number of circles of the first circular antenna array, a quantity of antenna elements in one or more circles of the first circular antenna array, a quantity of power amplifiers for the one or more circles, a quantity of digital beamformers for the one or more circles, or a combination thereof.

In some examples, to support receiving the first signal and the second signal, the communication interface 1055 may be configured as or otherwise support a means for receiving the first signal using the first OAM mode and the second signal using the second OAM mode based on a topology of the first circular antenna array, a topology of a second circular antenna array of a second device, or a combination thereof.

In some examples, to support receiving the first signal and the second signal, the first mode component 1030 may be configured as or otherwise support a means for receiving the first signal including a first set of reference signals. In some examples, to support receiving the first signal and the second signal, the second mode component 1035 may be configured as or otherwise support a means for receiving the second signal including a second set of reference signals.

In some examples, the feedback interface 1075 may be configured as or otherwise support a means for transmitting, to a second device based on receiving the first set of reference signals and the second set of reference signals, a feedback message indicating one or more channel quality indications corresponding to each antenna element of a second quantity of antenna elements of the second device, each OAM mode used by the second device, or a combination thereof.

In some examples, each antenna element of the first subset and each antenna element of the second subset are disposed in the circle in an alternating pattern.

In some examples, the third mode component 1065 may be configured as or otherwise support a means for receiving a third signal using a third OAM mode and a first subset of a second quantity of antenna elements disposed in a second circle. In some examples, the fourth mode component 1070 may be configured as or otherwise support a means for receiving a fourth signal using a fourth OAM mode and a second subset of the second quantity of antenna elements disposed in the second circle. In some examples, the decoding component 1040 may be configured as or otherwise support a means for decoding the third signal received using the third OAM mode and the first subset of the second quantity of antenna elements and the fourth signal received using the fourth OAM mode and the second subset of the second quantity of antenna elements.

In some examples, the first quantity of antenna elements are positioned at a first set of radial lines of the circle and the second quantity of antenna elements are positioned a second set of radial lines in the second circle. In some examples, the second set of radial lines are offset between the first set of radial lines.

In some examples, the first quantity of antenna elements are positioned at a first set of radial lines of the circle and the second quantity of antenna elements are positioned a second set of radial lines in the second circle. In some examples, the second set of radial lines are parallel with the first set of radial lines.

In some examples, the communication interface 1055 may be configured as or otherwise support a means for receiving, from a second device, the first signal and the second signal using the first quantity of antenna elements that are radially offset from a second quantity of antenna elements of the second device.

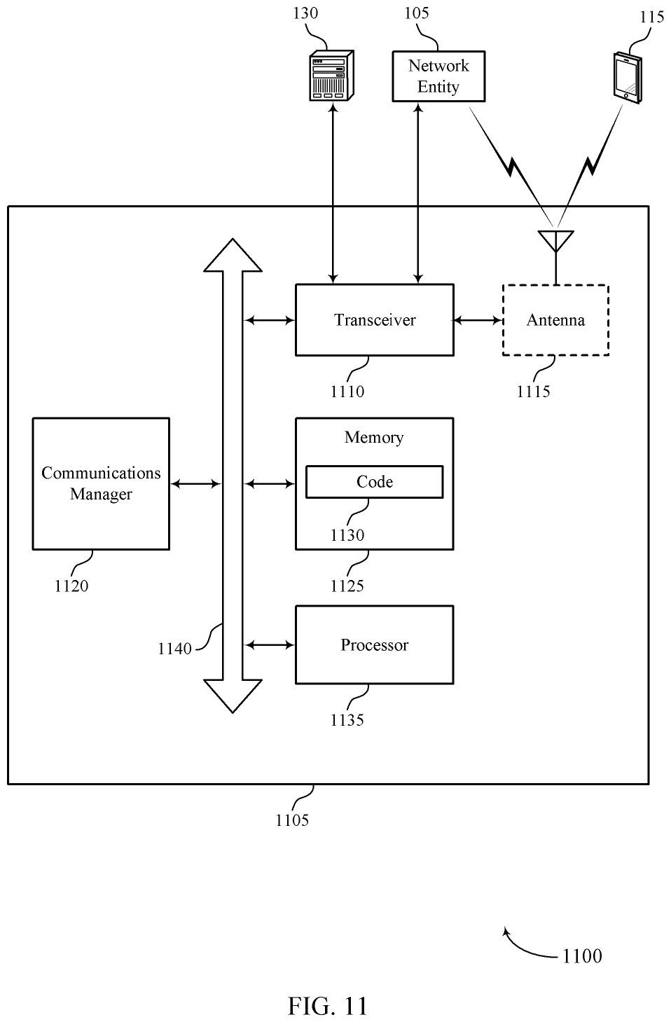

FIG. 11 shows a diagram of a system 1100 including a device 1105 that supports OAM multiplexing using multiple modes in an antenna array in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. The transceiver 1110, or the transceiver 1110 and one or more antennas 1115 or wired interfaces, where applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1125 may include random access memory (RAM) and read-only memory (ROM). The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a basic input/output (I/O) system (BIOS) which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting OAM multiplexing using multiple modes in an antenna array). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a first device in accordance with examples as disclosed herein. For example, the communications manager 1120 may be configured as or otherwise support a means for generating a set of multiple signals for transmission from the first device via a first circular antenna array that includes a first quantity of antenna elements disposed in a circle. The communications manager 1120 may be configured as or otherwise support a means for transmitting a first signal of the set of multiple signals using a first OAM mode and a first subset of the first quantity of antenna elements disposed in the circle. The communications manager 1120 may be configured as or otherwise support a means for transmitting a second signal of the set of multiple signals using a second OAM mode and a second subset of the first quantity of antenna elements disposed in the circle, where the second subset is exclusive of the first subset.

Additionally, or alternatively, the communications manager 1120 may support wireless communication at a first device in accordance with examples as disclosed herein. For example, the communications manager 1120 may be configured as or otherwise support a means for receiving, at a first circular antenna array including a first quantity of antenna elements disposed in a circle, a first signal of a set of multiple signals using a first OAM mode and a first subset of the first quantity of antenna elements disposed in the circle. The communications manager 1120 may be configured as or otherwise support a means for receiving a second signal of the set of multiple signals using a second OAM mode and a second subset of the first quantity of antenna elements disposed in the circle, where the second subset is exclusive of the first subset. The communications manager 1120 may be configured as or otherwise support a means for decoding the first signal received using the first OAM mode and the first subset and the second signal received using the second OAM mode and the second subset.

By including or configuring the communications manager 1120 in accordance with examples as described herein, the device 1105 may support techniques for improved communication reliability, improved throughput, reduced power consumption, more efficient utilization of communication resources, and improved coordination between devices. For example, the device 1105 may include a first circular antenna array and may support communications with a second device by using multiple OAM modes via the first circular antenna array. By supporting communications between such devices and using multiple modes in a circle of antenna elements, the number of power amplifiers for operations may be reduced, which may provide for improved utilization of resources and reduced power consumption. Additionally, using multiple OAM modes in a single circle may provider higher degrees-of-freedom at a smaller array gain, which may improve throughput of communications. In some aspects, an angular offset may be configured between an antenna subarray of the device 1105 and an antenna subarray of the other device, which may reduce aliasing and improve throughput. In some aspects, the device 1105 may transmit or receive a feedback message from a second device that indicates information for the device 1105 to use to generate and transmit signals to the second device. The feedback information may improve coordination between devices, reduce latency, and reduce processing. For example, the device 1105 may refrain from reporting certain channel quality measurements in order to reduce signaling overhead. In some aspects, an angular offset may be configured between an antenna subarray of the device 1105 and an antenna subarray of the other device, which may reduce aliasing and improve throughput.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the processor 1135, the memory 1125, the code 1130, the transceiver 1110, or any combination thereof. For example, the code 1130 may include instructions executable by the processor 1135 to cause the device 1105 to perform various aspects of OAM multiplexing using multiple modes in an antenna array as described herein, or the processor 1135 and the memory 1125 may be otherwise configured to perform or support such operations.

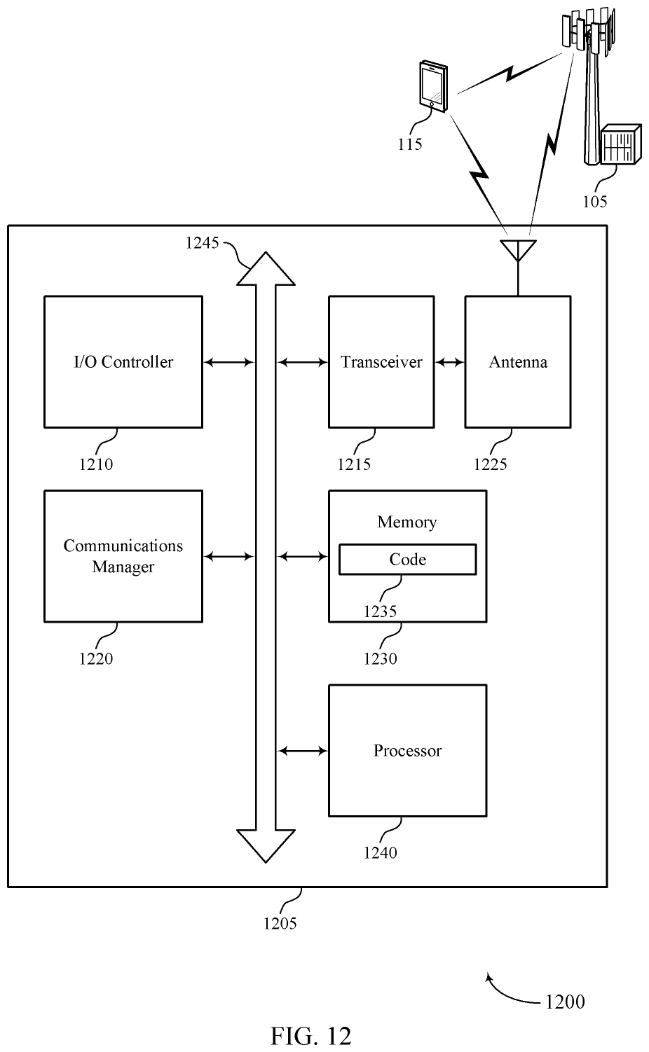

FIG. 12 shows a diagram of a system 1200 including a device 1205 that supports OAM multiplexing using multiple modes in an antenna array in accordance with one or more aspects of the present disclosure. The device 1205 may be an example of or include the components of a device 805, a device 905, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an I/O controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 815, a transmitter 915, a receiver 810, a receiver 910, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting OAM multiplexing using multiple modes in an antenna array). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a first device in accordance with examples as disclosed herein. For example, the communications manager 1220 may be configured as or otherwise support a means for generating a set of multiple signals for transmission from the first device via a first circular antenna array that includes a first quantity of antenna elements disposed in a circle. The communications manager 1220 may be configured as or otherwise support a means for transmitting a first signal of the set of multiple signals using a first OAM mode and a first subset of the first quantity of antenna elements disposed in the circle. The communications manager 1220 may be configured as or otherwise support a means for transmitting a second signal of the set of multiple signals using a second OAM mode and a second subset of the first quantity of antenna elements disposed in the circle, where the second subset is exclusive of the first subset.

Additionally, or alternatively, the communications manager 1220 may support wireless communication at a first device in accordance with examples as disclosed herein. For example, the communications manager 1220 may be configured as or otherwise support a means for receiving, at a first circular antenna array including a first quantity of antenna elements disposed in a circle, a first signal of a set of multiple signals using a first OAM mode and a first subset of the first quantity of antenna elements disposed in the circle. The communications manager 1220 may be configured as or otherwise support a means for receiving a second signal of the set of multiple signals using a second OAM mode and a second subset of the first quantity of antenna elements disposed in the circle, where the second subset is exclusive of the first subset. The communications manager 1220 may be configured as or otherwise support a means for decoding the first signal received using the first OAM mode and the first subset and the second signal received using the second OAM mode and the second subset.

By including or configuring the communications manager 1220 in accordance with examples as described herein, the device 1205 may support techniques for improved communication reliability, improved throughput, reduced power consumption, more efficient utilization of communication resources, and improved coordination between devices. For example, the device 1205 may include a first circular antenna array and may support communications with a second device by using multiple OAM modes via the first circular antenna array. By supporting communications between such devices and using multiple modes in a circle of antenna elements, the number of power amplifiers for operations may be reduced, which may provide for improved utilization of resources and reduced power consumption. Additionally, using multiple OAM modes in a single circle may provider higher degrees-of-freedom at a smaller array gain, which may improve throughput of communications. In some aspects, an angular offset may be configured between an antenna subarray of the device 1205 and an antenna subarray of the other device, which may reduce aliasing and improve throughput. In some aspects, the device 1205 may transmit or receive a feedback message from a second device that indicates information for the device 1205 to use to generate and transmit signals to the second device. The feedback information may improve coordination between devices, reduce latency, and reduce processing. For example, the device 1205 may refrain from reporting certain channel quality measurements in order to reduce signaling overhead. In some aspects, an angular offset may be configured between an antenna subarray of the device 1205 and an antenna subarray of the other device, which may reduce aliasing and improve throughput.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of OAM multiplexing using multiple modes in an antenna array as described herein, or the processor 1240 and the memory 1230 may be otherwise configured to perform or support such operations.

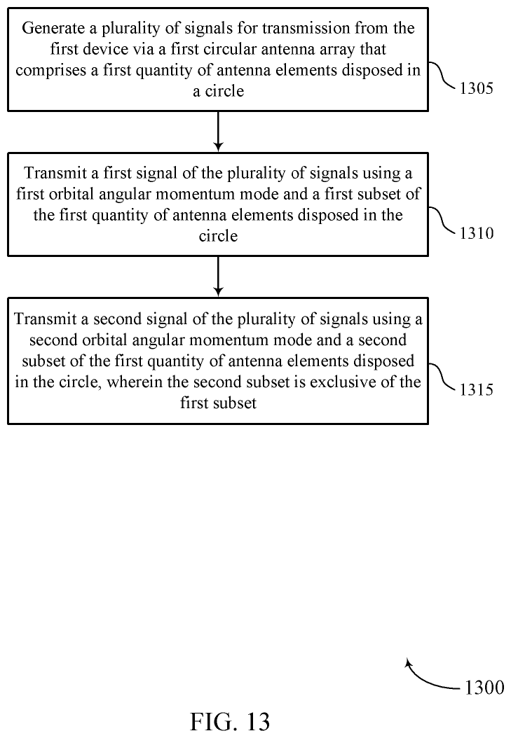

FIG. 13 shows a flowchart illustrating a method 1300 that supports OAM multiplexing using multiple modes in an antenna array in accordance with one or more aspects of the present disclosure. The operations of the method 1300 may be implemented by a network entity or a UE or its components as described herein. For example, the operations of the method 1300 may be performed by a network entity or a UE 115 as described with reference to FIGS. 1 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1305, the method may include generating a set of multiple signals for transmission from the first device via a first circular antenna array that includes a first quantity of antenna elements disposed in a circle. The operations of 1305 may be performed in accordance with examples as disclosed herein. In some examples, aspects of the operations of 1305 may be performed by a signal generating component 1025 as described with reference to FIG. 10.

At 1310, the method may include transmitting a first signal of the set of multiple signals using a first OAM mode and a first subset of the first quantity of antenna elements disposed in the circle. The operations of 1310 may be performed in accordance with examples as disclosed herein. In some examples, aspects of the operations of 1310 may be performed by a first mode component 1030 as described with reference to FIG. 10.

At 1315, the method may include transmitting a second signal of the set of multiple signals using a second OAM mode and a second subset of the first quantity of antenna elements disposed in the circle, where the second subset is exclusive of the first subset. The operations of 1315 may be performed in accordance with examples as disclosed herein. In some examples, aspects of the operations of 1315 may be performed by a second mode component 1035 as described with reference to FIG. 10.

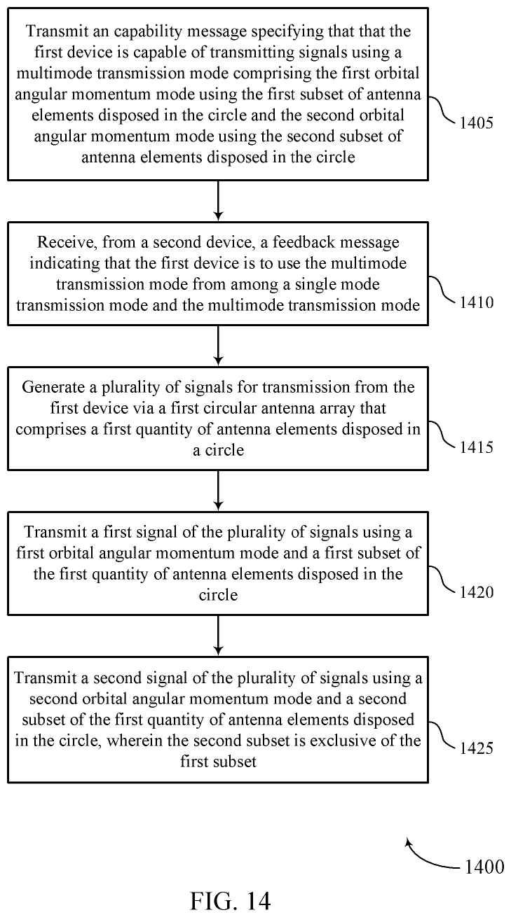

FIG. 14 shows a flowchart illustrating a method 1400 that supports OAM multiplexing using multiple modes in an antenna array in accordance with one or more aspects of the present disclosure. The operations of the method 1400 may be implemented by a network entity or a UE or its components as described herein. For example, the operations of the method 1400 may be performed by a network entity or a UE 115 as described with reference to FIGS. 1 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1405, the method may include transmitting an capability message specifying that that the first device is capable of transmitting signals using a multimode transmission mode including the first OAM mode using the first subset of antenna elements disposed in the circle and the second OAM mode using the second subset of antenna elements disposed in the circle. The operations of 1405 may be performed in accordance with examples as disclosed herein. In some examples, aspects of the operations of 1405 may be performed by a capability message interface 1045 as described with reference to FIG. 10.

At 1410, the method may include receiving, from a second device, a feedback message indicating that the first device is to use the multimode transmission mode from among a single mode transmission mode and the multimode transmission mode. The operations of 1410 may be performed in accordance with examples as disclosed herein. In some examples, aspects of the operations of 1410 may be performed by a feedback interface 1075 as described with reference to FIG. 10.

At 1415, the method may include generating a set of multiple signals for transmission from the first device via a first circular antenna array that includes a first quantity of antenna elements disposed in a circle. The operations of 1415 may be performed in accordance with examples as disclosed herein. In some examples, aspects of the operations of 1415 may be performed by a signal generating component 1025 as described with reference to FIG. 10.

At 1420, the method may include transmitting a first signal of the set of multiple signals using a first OAM mode and a first subset of the first quantity of antenna elements disposed in the circle. The operations of 1420 may be performed in accordance with examples as disclosed herein. In some examples, aspects of the operations of 1420 may be performed by a first mode component 1030 as described with reference to FIG. 10.

At 1425, the method may include transmitting a second signal of the set of multiple signals using a second OAM mode and a second subset of the first quantity of antenna elements disposed in the circle, where the second subset is exclusive of the first subset. The operations of 1425 may be performed in accordance with examples as disclosed herein. In some examples, aspects of the operations of 1425 may be performed by a second mode component 1035 as described with reference to FIG. 10.

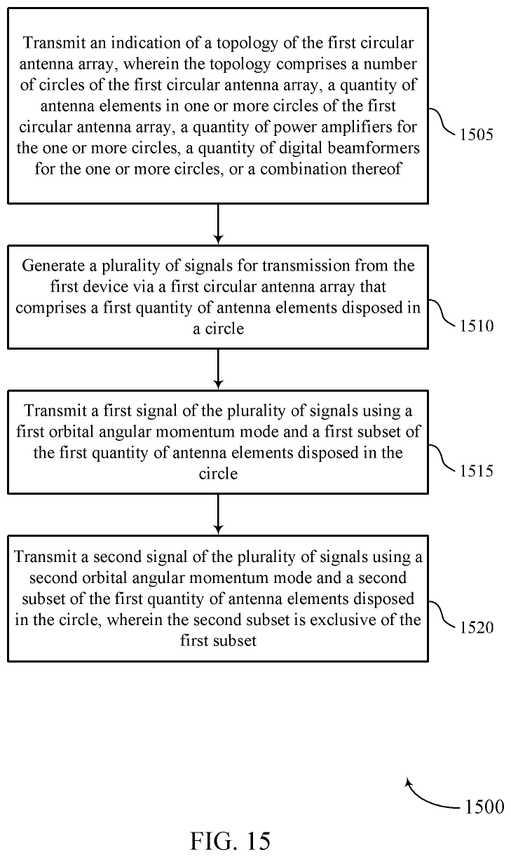

FIG. 15 shows a flowchart illustrating a method 1500 that supports OAM multiplexing using multiple modes in an antenna array in accordance with one or more aspects of the present disclosure. The operations of the method 1500 may be implemented by a network entity or a UE or its components as described herein. For example, the operations of the method 1500 may be performed by a network entity or a UE 115 as described with reference to FIGS. 1 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1505, the method may include transmitting an indication of a topology of the first circular antenna array, where the topology includes a number of circles of the first circular antenna array, a quantity of antenna elements in one or more circles of the first circular antenna array, a quantity of power amplifiers for the one or more circles, a quantity of digital beamformers for the one or more circles, or a combination thereof. The operations of 1505 may be performed in accordance with examples as disclosed herein. In some examples, aspects of the operations of 1505 may be performed by a topology message interface 1050 as described with reference to FIG. 10.

At 1510, the method may include generating a set of multiple signals for transmission from the first device via a first circular antenna array that includes a first quantity of antenna elements disposed in a circle. The operations of 1510 may be performed in accordance with examples as disclosed herein. In some examples, aspects of the operations of 1510 may be performed by a signal generating component 1025 as described with reference to FIG. 10.

At 1515, the method may include transmitting a first signal of the set of multiple signals using a first OAM mode and a first subset of the first quantity of antenna elements disposed in the circle. The operations of 1515 may be performed in accordance with examples as disclosed herein. In some examples, aspects of the operations of 1515 may be performed by a first mode component 1030 as described with reference to FIG. 10.

At 1520, the method may include transmitting a second signal of the set of multiple signals using a second OAM mode and a second subset of the first quantity of antenna elements disposed in the circle, where the second subset is exclusive of the first subset. The operations of 1520 may be performed in accordance with examples as disclosed herein. In some examples, aspects of the operations of 1520 may be performed by a second mode component 1035 as described with reference to FIG. 10.

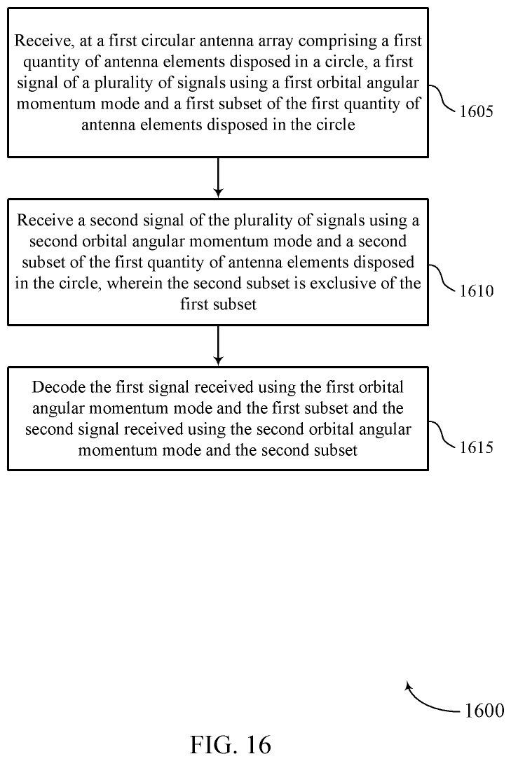

FIG. 16 shows a flowchart illustrating a method 1600 that supports OAM multiplexing using multiple modes in an antenna array in accordance with one or more aspects of the present disclosure. The operations of the method 1600 may be implemented by a network entity or a UE or its components as described herein. For example, the operations of the method 1600 may be performed by a network entity or a UE 115 as described with reference to FIGS. 1 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1605, the method may include receiving, at a first circular antenna array including a first quantity of antenna elements disposed in a circle, a first signal of a set of multiple signals using a first OAM mode and a first subset of the first quantity of antenna elements disposed in the circle. The operations of 1605 may be performed in accordance with examples as disclosed herein. In some examples, aspects of the operations of 1605 may be performed by a first mode component 1030 as described with reference to FIG. 10.

At 1610, the method may include receiving a second signal of the set of multiple signals using a second OAM mode and a second subset of the first quantity of antenna elements disposed in the circle, where the second subset is exclusive of the first subset. The operations of 1610 may be performed in accordance with examples as disclosed herein. In some examples, aspects of the operations of 1610 may be performed by a second mode component 1035 as described with reference to FIG. 10.

At 1615, the method may include decoding the first signal received using the first OAM mode and the first subset and the second signal received using the second OAM mode and the second subset. The operations of 1615 may be performed in accordance with examples as disclosed herein. In some examples, aspects of the operations of 1615 may be performed by a decoding component 1040 as described with reference to FIG. 10.

The following provides an overview of aspects of the present disclosure:

Aspect 1: A method for wireless communication at a first device, comprising: generating a plurality of signals for transmission from the first device via a first circular antenna array that comprises a first quantity of antenna elements disposed in a circle; transmitting a first signal of the plurality of signals using a first orbital angular momentum mode and a first subset of the first quantity of antenna elements disposed in the circle; and transmitting a second signal of the plurality of signals using a second orbital angular momentum mode and a second subset of the first quantity of antenna elements disposed in the circle, wherein the second subset is exclusive of the first subset.

Aspect 2: The method of aspect 1, further comprising: transmitting an capability message specifying that that the first device is capable of transmitting signals using a multimode transmission mode comprising the first orbital angular momentum mode using the first subset of antenna elements disposed in the circle and the second orbital angular momentum mode using the second subset of antenna elements disposed in the circle.

Aspect 3: The method of aspect 2, wherein transmitting the capability message comprises: transmitting the capability message using a radio resource control signal or a system broadcast signal.

Aspect 4: The method of any of aspects 2 through 3, further comprising: receiving, from a second device, a feedback message indicating that the first device is to use the multimode transmission mode from among a single mode transmission mode and the multimode transmission mode.

Aspect 5: The method of any of aspects 1 through 4, further comprising: transmitting an indication of a topology of the first circular antenna array, wherein the topology comprises a number of circles of the first circular antenna array, a quantity of antenna elements in one or more circles of the first circular antenna array, a quantity of power amplifiers for the one or more circles, a quantity of digital beamformers for the one or more circles, or a combination thereof.

Aspect 6: The method of any of aspects 1 through 5, further comprising: receiving, from a second device, an indication of a topology of a second circular antenna array of the second device, wherein the topology comprises a number of circles of the second circular antenna array, a quantity of antenna elements in one or more circles of the second circular antenna array, a quantity of power amplifiers for the one or more circles, a quantity of digital beamformers for the one or more circles, or a combination thereof.

Aspect 7: The method of any of aspects 1 through 6, wherein transmitting the first signal and transmitting the second signal comprises: transmitting the first signal using the first orbital angular momentum mode and the second signal using the second orbital angular momentum mode based at least in part on a topology of the first circular antenna array, a topology of a second circular antenna array of a second device, or a combination thereof.

Aspect 8: The method of any of aspects 1 through 7, wherein transmitting the first signal and transmitting the second signal comprises: transmitting the first signal comprising a first set of reference signals; and transmitting the second signal comprising a second set of reference signals.

Aspect 9: The method of aspect 8, further comprising: receiving, from a second device based at least in part on transmitting the first set of reference signals and the second set of reference signals, a feedback message indicating one or more channel quality indications corresponding to each antenna element of the first quantity of antenna elements, each mode of the first orbital angular momentum mode and the second orbital angular momentum mode, or a combination thereof.

Aspect 10: The method of aspect 9, further comprising: transmitting one or more subsequent signals using the first orbital angular momentum mode, the second orbital angular momentum mode, or both, based at least in part on the one or more channel quality indications.

Aspect 11: The method of any of aspects 1 through 10, wherein each antenna element of the first subset and each antenna element of the second subset are disposed in the circle in an alternating pattern.

Aspect 12: The method of any of aspects 1 through 11, wherein transmitting the first signal and transmitting the second signal comprises: transmitting the first signal using a first power applied by a first power amplifier corresponding to the first subset of antenna elements and the first orbital angular momentum mode; and transmitting the second signal using a second power applied by a second power amplifier corresponding to the second subset of antenna elements and the second orbital angular momentum mode.

Aspect 13: The method of any of aspects 1 through 12, further comprising: applying a set of beamforming weights for transmission of the first signal and the second signal using a first quantity of phasors, wherein each phasor of the first quantity of phasors corresponds to a respective antenna element of the first quantity of antenna elements.

Aspect 14: The method of any of aspects 1 through 13, further comprising: generating a second plurality of signals for transmission from the first device via the first circular antenna array that comprises a second quantity of antenna elements disposed in a second circle; transmitting a first signal of the second plurality of signals using a third orbital angular momentum mode and a first subset of the second quantity of antenna elements disposed in the second circle; and transmitting a second signal of the second plurality of signals using a fourth orbital angular momentum mode and a second subset of the second quantity of antenna elements disposed in the second circle, wherein the second subset of the second quantity of antenna elements is exclusive of the first subset of the second quantity of antenna elements and wherein the circle and the second circle are concentric.

Aspect 15: The method of aspect 14, wherein the first quantity of antenna elements are positioned at a first set of radial lines of the circle; and the second quantity of antenna elements are positioned a second set of radial lines in the second circle and the second set of radial lines are offset between the first set of radial lines.

Aspect 16: The method of any of aspects 14 through 15, wherein the first quantity of antenna elements are positioned at a first set of radial lines of the circle and the second quantity of antenna elements are positioned a second set of radial lines in the second circle; and the second set of radial lines are parallel with the first set of radial lines.

Aspect 17: The method of any of aspects 1 through 16, wherein transmitting the first signal and transmitting the second signal comprises: transmitting, to a second device, the first signal and the second signal using the first quantity of antenna elements that are radially offset from a second quantity of antenna elements of the second device.

Aspect 18: A method for wireless communication at a first device, comprising: receiving, at a first circular antenna array comprising a first quantity of antenna elements disposed in a circle, a first signal of a plurality of signals using a first orbital angular momentum mode and a first subset of the first quantity of antenna elements disposed in the circle; receiving a second signal of the plurality of signals using a second orbital angular momentum mode and a second subset of the first quantity of antenna elements disposed in the circle, wherein the second subset is exclusive of the first subset; and decoding the first signal received using the first orbital angular momentum mode and the first subset and the second signal received using the second orbital angular momentum mode and the second subset.

Aspect 19: The method of aspect 18, further comprising: receiving, from a second device, a capability message specifying that that the first device is capable of transmitting signals using a multimode transmission mode.

Aspect 20: The method of aspect 19, wherein receiving the capability message comprises: receiving the capability message using a radio resource control signal or a system broadcast signal.

Aspect 21: The method of any of aspects 19 through 20, further comprising: transmitting, to the second device, a feedback message indicating that the first device is to use the multimode transmission mode from among a single mode transmission mode and the multimode transmission mode.

Aspect 22: The method of any of aspects 18 through 21, further comprising: receiving, from a second device, an indication of a topology of a second circular antenna array of the second device, wherein the topology comprises a number of circles of the second circular antenna array, a quantity of antenna elements in one or more circles of the second circular antenna array, a quantity of power amplifiers for the one or more circles, a quantity of digital beamformers for the one or more circles, or a combination thereof.

Aspect 23: The method of any of aspects 18 through 22, further comprising: transmitting, to a second device, an indication of a topology of the first circular antenna array, wherein the topology comprises a number of circles of the first circular antenna array, a quantity of antenna elements in one or more circles of the first circular antenna array, a quantity of power amplifiers for the one or more circles, a quantity of digital beamformers for the one or more circles, or a combination thereof.

Aspect 24: The method of any of aspects 18 through 23, wherein receiving the first signal and the second signal comprises: receiving the first signal using the first orbital angular momentum mode and the second signal using the second orbital angular momentum mode based at least in part on a topology of the first circular antenna array, a topology of a second circular antenna array of a second device, or a combination thereof.

Aspect 25: The method of any of aspects 18 through 24, wherein receiving the first signal and the second signal comprises: receiving the first signal comprising a first set of reference signals; and receiving the second signal comprising a second set of reference signals.

Aspect 26: The method of aspect 25, further comprising: transmitting, to a second device based at least in part on receiving the first set of reference signals and the second set of reference signals, a feedback message indicating one or more channel quality indications corresponding to each antenna element of a second quantity of antenna elements of the second device, each orbital angular momentum mode used by the second device, or a combination thereof.

Aspect 27: The method of any of aspects 18 through 26, wherein each antenna element of the first subset and each antenna element of the second subset are disposed in the circle in an alternating pattern.

Aspect 28: The method of any of aspects 18 through 27, further comprising: receiving a third signal using a third orbital angular momentum mode and a first subset of a second quantity of antenna elements disposed in a second circle; receiving a fourth signal using a fourth orbital angular momentum mode and a second subset of the second quantity of antenna elements disposed in the second circle; and decoding the third signal received using the third orbital angular momentum mode and the first subset of the second quantity of antenna elements and the fourth signal received using the fourth orbital angular momentum mode and the second subset of the second quantity of antenna elements.

Aspect 29: The method of aspect 28, wherein the first quantity of antenna elements are positioned at a first set of radial lines of the circle and the second quantity of antenna elements are positioned a second set of radial lines in the second circle, the second set of radial lines are offset between the first set of radial lines.

Aspect 30: The method of any of aspects 28 through 29, wherein the first quantity of antenna elements are positioned at a first set of radial lines of the circle and the second quantity of antenna elements are positioned a second set of radial lines in the second circle, the second set of radial lines are parallel with the first set of radial lines.

Aspect 31: The method of any of aspects 18 through 30, further comprising: receiving, from a second device, the first signal and the second signal using the first quantity of antenna elements that are radially offset from a second quantity of antenna elements of the second device.

Aspect 32: An apparatus for wireless communication at a first device, comprising a processor; memory coupled with the processor; and instructions stored in the memory and executable by the processor to cause the apparatus to perform a method of any of aspects 1 through 17.

Aspect 33: An apparatus for wireless communication at a first device, comprising at least one means for performing a method of any of aspects 1 through 17.

Aspect 34: A non-transitory computer-readable medium storing code for wireless communication at a first device, the code comprising instructions executable by a processor to perform a method of any of aspects 1 through 17.

Aspect 35: An apparatus for wireless communication at a first device, comprising a processor; memory coupled with the processor; and instructions stored in the memory and executable by the processor to cause the apparatus to perform a method of any of aspects 18 through 31.

Aspect 36: An apparatus for wireless communication at a first device, comprising at least one means for performing a method of any of aspects 18 through 31.

Aspect 37: A non-transitory computer-readable medium storing code for wireless communication at a first device, the code comprising instructions executable by a processor to perform a method of any of aspects 18 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first device, comprising:
generating a plurality of signals for transmission from the first device via a first circular antenna array that comprises a first quantity of antenna elements disposed in a circle;
transmitting a first signal of the plurality of signals using a first orbital angular momentum mode and a first subset of the first quantity of antenna elements disposed in the circle; and
transmitting a second signal of the plurality of signals using a second orbital angular momentum mode and a second subset of the first quantity of antenna elements disposed in the circle, wherein the second subset is exclusive of the first subset.

2. The method of claim 1, further comprising:
transmitting an capability message specifying that that the first device is capable of transmitting signals using a multimode transmission mode comprising the first orbital angular momentum mode using the first subset of antenna elements disposed in the circle and the second orbital angular momentum mode using the second subset of antenna elements disposed in the circle.

3. The method of claim 2, wherein transmitting the capability message comprises:
transmitting the capability message using a radio resource control signal or a system broadcast signal.

4. The method of claim 2, further comprising:
receiving, from a second device, a feedback message indicating that the first device is to use the multimode transmission mode from among a single mode transmission mode and the multimode transmission mode.

5. The method of claim 1, further comprising:
transmitting an indication of a topology of the first circular antenna array, wherein the topology comprises a number of circles of the first circular antenna array, a quantity of antenna elements in one or more circles of the first circular antenna array, a quantity of power amplifiers for the one or more circles, a quantity of digital beamformers for the one or more circles, or a combination thereof.

6. The method of claim 1, further comprising:
receiving, from a second device, an indication of a topology of a second circular antenna array of the second device, wherein the topology comprises a number of circles of the second circular antenna array, a quantity of antenna elements in one or more circles of the second circular antenna array, a quantity of power amplifiers for the one or more circles, a quantity of digital beamformers for the one or more circles, or a combination thereof.

7. The method of claim 1, wherein transmitting the first signal and transmitting the second signal comprises:
transmitting the first signal using the first orbital angular momentum mode and the second signal using the second orbital angular momentum mode based at least in part on a topology of the first circular antenna array, a topology of a second circular antenna array of a second device, or a combination thereof.

8. The method of claim 1, wherein transmitting the first signal and transmitting the second signal comprises:
transmitting the first signal comprising a first set of reference signals; and
transmitting the second signal comprising a second set of reference signals.

9. The method of claim 8, further comprising:
receiving, from a second device based at least in part on transmitting the first set of reference signals and the second set of reference signals, a feedback message indicating one or more channel quality indications corresponding to each antenna element of the first quantity of antenna elements, each mode of the first orbital angular momentum mode and the second orbital angular momentum mode, or a combination thereof.

10. The method of claim 9, further comprising:
transmitting one or more subsequent signals using the first orbital angular momentum mode, the second orbital angular momentum mode, or both, based at least in part on the one or more channel quality indications.

11. The method of claim 1, wherein each antenna element of the first subset and each antenna element of the second subset are disposed in the circle in an alternating pattern.

12. The method of claim 1, wherein transmitting the first signal and transmitting the second signal comprises:
transmitting the first signal using a first power applied by a first power amplifier corresponding to the first subset of antenna elements and the first orbital angular momentum mode; and
transmitting the second signal using a second power applied by a second power amplifier corresponding to the second subset of antenna elements and the second orbital angular momentum mode.

13. The method of claim 1, further comprising:
applying a set of beamforming weights for transmission of the first signal and the second signal using a first quantity of phasors, wherein each phasor of the first quantity of phasors corresponds to a respective antenna element of the first quantity of antenna elements.

14. The method of claim 1, further comprising:
generating a second plurality of signals for transmission from the first device via the first circular antenna array that comprises a second quantity of antenna elements disposed in a second circle;
transmitting a first signal of the second plurality of signals using a third orbital angular momentum mode and a first subset of the second quantity of antenna elements disposed in the second circle; and
transmitting a second signal of the second plurality of signals using a fourth orbital angular momentum mode and a second subset of the second quantity of antenna elements disposed in the second circle, wherein the second subset of the second quantity of antenna elements is exclusive of the first subset of the second quantity of antenna elements and wherein the circle and the second circle are concentric.

15. The method of claim 14, wherein:
the first quantity of antenna elements are positioned at a first set of radial lines of the circle; and
the second quantity of antenna elements are positioned a second set of radial lines in the second circle and the second set of radial lines are offset between the first set of radial lines.

16. The method of claim 14, wherein:
the first quantity of antenna elements are positioned at a first set of radial lines of the circle and the second quantity of antenna elements are positioned a second set of radial lines in the second circle; and
the second set of radial lines are parallel with the first set of radial lines.

17. The method of claim 1, wherein transmitting the first signal and transmitting the second signal comprises:
transmitting, to a second device, the first signal and the second signal using the first quantity of antenna elements that are radially offset from a second quantity of antenna elements of the second device.

18. A method for wireless communication at a first device, comprising:
receiving, at a first circular antenna array comprising a first quantity of antenna elements disposed in a circle, a first signal of a plurality of signals using a first orbital angular momentum mode and a first subset of the first quantity of antenna elements disposed in the circle;
receiving a second signal of the plurality of signals using a second orbital angular momentum mode and a second subset of the first quantity of antenna elements disposed in the circle, wherein the second subset is exclusive of the first subset; and
decoding the first signal received using the first orbital angular momentum mode and the first subset and the second signal received using the second orbital angular momentum mode and the second subset.

19. The method of claim 18, further comprising:
receiving, from a second device, a capability message specifying that that the first device is capable of transmitting signals using a multimode transmission mode.

20. The method of claim 19, wherein receiving the capability message comprises:
receiving the capability message using a radio resource control signal or a system broadcast signal.

21. The method of claim 19, further comprising:
transmitting, to the second device, a feedback message indicating that the first device is to use the multimode transmission mode from among a single mode transmission mode and the multimode transmission mode.

22. The method of claim 18, further comprising:
receiving, from a second device, an indication of a topology of a second circular antenna array of the second device, wherein the topology comprises a number of circles of the second circular antenna array, a quantity of antenna elements in one or more circles of the second circular antenna array, a quantity of power amplifiers for the one or more circles, a quantity of digital beamformers for the one or more circles, or a combination thereof.

23. The method of claim 18, further comprising:
transmitting, to a second device, an indication of a topology of the first circular antenna array, wherein the topology comprises a number of circles of the first circular antenna array, a quantity of antenna elements in one or more circles of the first circular antenna array, a quantity of power amplifiers for the one or more circles, a quantity of digital beamformers for the one or more circles, or a combination thereof.

24. The method of claim 18, wherein receiving the first signal and the second signal comprises:
receiving the first signal using the first orbital angular momentum mode and the second signal using the second orbital angular momentum mode based at least in part on a topology of the first circular antenna array, a topology of a second circular antenna array of a second device, or a combination thereof.

25. The method of claim 18, wherein receiving the first signal and the second signal comprises:
receiving the first signal comprising a first set of reference signals; and
receiving the second signal comprising a second set of reference signals.

26. The method of claim 25, further comprising:
transmitting, to a second device based at least in part on receiving the first set of reference signals and the second set of reference signals, a feedback message indicating one or more channel quality indications corresponding to each antenna element of a second quantity of antenna elements of the second device, each orbital angular momentum mode used by the second device, or a combination thereof.

27. The method of claim 18, wherein each antenna element of the first subset and each antenna element of the second subset are disposed in the circle in an alternating pattern.

28. The method of claim 18, further comprising:
receiving a third signal using a third orbital angular momentum mode and a first subset of a second quantity of antenna elements disposed in a second circle;
receiving a fourth signal using a fourth orbital angular momentum mode and a second subset of the second quantity of antenna elements disposed in the second circle; and
decoding the third signal received using the third orbital angular momentum mode and the first subset of the second quantity of antenna elements and the fourth signal received using the fourth orbital angular momentum mode and the second subset of the second quantity of antenna elements.

29. An apparatus for wireless communication at a first device, comprising:
a processor;
memory coupled with the processor; and
instructions stored in the memory and executable by the processor to cause the apparatus to:
generate a plurality of signals for transmission from the first device via a first circular antenna array that comprises a first quantity of antenna elements disposed in a circle;
transmit a first signal of the plurality of signals using a first orbital angular momentum mode and a first subset of the first quantity of antenna elements disposed in the circle; and
transmit a second signal of the plurality of signals using a second orbital angular momentum mode and a second subset of the first quantity of antenna elements disposed in the circle, wherein the second subset is exclusive of the first subset.

30. An apparatus for wireless communication at a first device, comprising:
a processor;
memory coupled with the processor; and
instructions stored in the memory and executable by the processor to cause the apparatus to:
receive, at a first circular antenna array comprising a first quantity of antenna elements disposed in a circle, a first signal of a plurality of signals using a first orbital angular momentum mode and a first subset of the first quantity of antenna elements disposed in the circle;
receive a second signal of the plurality of signals using a second orbital angular momentum mode and a second subset of the first quantity of antenna elements disposed in the circle, wherein the second subset is exclusive of the first subset; and
decode the first signal received using the first orbital angular momentum mode and the first subset and the second signal received using the second orbital angular momentum mode and the second subset.
